(19) United States
(12) Patent Application Publication
(10) Pub. No.: US 2007/0042770 A1
(43) Pub. Date: Feb. 22, 2007

(54) Information distribution

(76) Inventors: Yutaka Yasui, Fuchu (JP); Norio Murakami, Kawasaki (JP)

Correspondence Address: KATTEN MUCHIN ROSENMAN LLP, 575 MADISON AVENUE, NEW YORK, NY, 10022-2585, US

(21) Appl. No.: 10/574,039

(22) PCT Filed: Oct. 15, 2003
(86) PCT No.: PCT/JP03/13188

§ 371 Date: Mar. 27, 2006

(51) Int. Cl. H04Q 7/20

(52) U.S. Cl. 455/428; 455/433

(57) ABSTRACT

The art relates to information distribution service providing technology. The server system predicts the distribution state of mobile information terminals in the future, based on the location information of mobile information terminals and change over time in the distribution state of service users (mobile information terminals) with a specific user characteristic in an information distribution object area. Based on the prediction, the server system carries out information distribution. This makes it possible to improve information distribution efficiency.

### CROSS REFERENCE TO RELATED APPLICATIONS

This application is based on and hereby claims priority to PCT International Application No. PCT/JP2003/01388 filed on Oct. 15, 2003, in Japan, the contents of which are hereby incorporated by reference.

### BACKGROUND OF THE INVENTION

(1) Field of the Invention

The present invention relates to an information distribution service providing system, and information distribution method in the same system, and a server system for use in the same system. The invention relates particularly to technology suitable for realizing a service which selectively distributes appropriately selected useful information to mobile information terminals, such as mobile phones. The invention also relates particularly to technology which realizes good effects of information distribution for the information distributor.

(2) Description of Related Art

Recently, the Internet has spread widely, and mobile information terminals, such as mobile phones, which can use Internet services such as e-mail have also become popular. In view of this situation, attention has been given to the possibility of a service in which information, such as advertisements, suitable in time and place are provided to mobile information terminals. Further, as mobile information terminals whose location can be recognized with high accuracy by means of GPS (Global Positioning System) have become commercially practical, the above-mentioned service is nearing practical use.

In the information distribution service proposed previously, it is assumed that information is distributed to a group of terminals which are present in an arbitrary area at an arbitrary time. In this case, the fact that the terminals move over time is taken in mind to some degree, but consideration is not paid to the terminals' movement as a terminal group.

On the other hand, at distribution of advertisements, quantitative measurement of the effects of the distributed advertisements has been desired. In the previous advertisement by mass media, the measurement (research) of the effects of advertising has been carried out, but its accuracy is significantly low. Further, such research has been carried out after the elapse of a significantly long time after the advertisement distribution, and hence, the accuracy of the research is not considered to be high.

Generally speaking, in information distribution services, there are a lot of service users and a lot of service providers, and it is assumed that each information provider distributes multiple notification messages to service users under different conditions. The following patent document 1 through 4 disclose such kinds of information distribution service. The art (a server system which distributes information to portable mobile information terminals in specified areas) of the following patent document 1 realizes the following information distribution service. That is,

(1) registration or contracts are established between service users (users of portable mobile information terminals) and a server system provider, and between the server system provider and information providers, with respect to use of the information distribution service;

(2) the server system receives the location information of the service users from moment to moment, and selects service users who are in an area specified by the information provider and whose characteristic agrees with that specified by the information provider, a short time before the time specified by the information provider;

(3) the server system sends a list of the selected terminals to the information provider, who then narrows down the terminals to which information is to be distributed. After that, the server system distributes information, such as advertisements, to the listed service users.

This arrangement makes it possible to notify only users who are present in a specified area of information which is closely related to the specified area. More concretely, when a registered person (information distribution requester) expects distribution of information about a bargain sale or a special event at a specific store, the information is distributed to service users who are present close to the specified store. In other words, notification to service users who are a considerable distance away from the specified store can be omitted (for example, if the stores exists in Tokyo, users in Kyushu and Hokkaido are excluded from the users to whom the information is to be distributed).

Further, the art (the construction of a communication service area in a mobile communication system, an information distribution method, and a mobile communication system) disclosed in the following patent document 2 relates to the construction of a communication service area in the cellular mobile communication system. In the art, a communication service area in which the mobile communication system provides a specified communication service to mobile terminals is formed. In addition, a special area, which overlaps the above communication service area and in which the mobile communication system can distribute information as a communication service which is different from the above specified communication service to the mobile terminals, is formed. As a result, in addition to general communication service, services other than normal services, which are localized information services, become available.

Further, the art (location registering method, information distribution method, mobile communication network, and mobile communication terminals) proposed in the following patent document 3 acknowledges (manages) the ID of the base station which is in charge of the radio zone, in which mobile communication terminals are present, in a specific area and the IDs of the mobile communication terminals, thereby recognizing the specific locations of the mobile communication terminals. Information relating to the location information is provided to the mobile communication terminals, whereby useful and suitable information corresponding to the location of the mobile communication terminals is provided to the users of the mobile terminals.

In addition, the art (advertisement information distribution system and advertisement information distribution method) disclosed in the following patent document 4 distributes advertisement information when specified operations are carried out by the user of a mobile information terminal. As a result, advertisement information is provided to the user without interfering with operations of the mobile information terminal by the user. By means of changing the contents of the advertisement information and the time when the advertisement is displayed, it is possible to provide users with flexible and precise advertisement information.

Patent Document 1:

Japanese Patent Application Laid-open No. 2002-216021

Patent Document 2:

Japanese Patent Application Laid-open No. 2002-262351

Patent Document 3:

Japanese Patent Application Laid-open No. 2002-84564

Patent Document 4:

Japanese Patent Application Laid-open No. 2002-290629

Here, the aim of the above-described information distribution is to build the name recognition of the information provider's products or its company name, and to increase consumer behavior of buying. Accordingly, the information provider who requests message distribution probably has a need to obtain objective evaluation of the effect of the information distribution, and a need for recognizing the distribution method which increases the effect of the information distribution. In addition the information provider would like to know the effects of the information distribution as accurately as possible and as soon as possible.

The previous information distribution service, including the art disclosed in the above patent document 1 through patent document 4, distributes information to service users who are present in a specified area at a specified time. By specifying a downtown area, in which it is clear that people gather, as the information distribution object area, it is possible to distribute information more effectively than in a case where information is distributed uniformly to a wide area. However, the previous art does not reveal anything about the method with which high distribution effectiveness is obtained or how to evaluate the effectiveness.

### SUMMARY OF THE INVENTION

With the foregoing problems in view, an object of the present invention is not only to perform information distribution to service users (mobile information terminals) who are present in a specified area at a specified time but also to monitor the distribution state of a mobile information terminal group and to predict the future distribution state, thereby improving the information distribution efficiency with high efficacy.

In order to accomplish the above object, according to the present invention, there is provided an information distribution service providing system, comprising: a server system which provides a plurality of mobile information terminals, carried by a plurality of users who have been registered as users of information distribution service, with the information distribution service via a communication network; and a terminal of an information distribution requester, which terminal communicates with the server system and specifies user property and information distribution object areas for the users to whom information is to be distributed by the information distribution service, the server system including:

(a) a distribution state change monitoring means which monitors change over time in distribution of the mobile information terminals of the users with the user property in the information distribution object area, based on location information of the mobile information terminal;

(b) a distribution state predicting means which predicts a distribution state of the mobile information terminals in the future based on the monitoring result obtained by the distribution state change monitoring means; and

(c) an information distributing means which distributes information to the mobile information terminals of the users based on the prediction result obtained by the distribution state predicting means.

As a preferred feature, the distribution state change monitoring means (a) includes: a distribution density calculating unit (a-1) which calculates distribution density of mobile information terminals of the service users with the user property, in a specified block included in the information distribution object area, based on location information of the mobile information terminal; and a high density distribution area detecting unit (a-2) which detects a high density distribution area, in which the distribution density is higher than a predetermined density, based on the calculation result obtained by the distribution density calculating unit, and the distribution state predicting means (b) includes: a high density distribution area movement displacement calculating unit (b-1) which calculates movement displacement of the high density distribution area detected by the high density distribution area detecting unit; and a high density distribution area movement predicting unit (b-2) which predicts a destination to which the high density distribution area moves, based on the movement displacement obtained by the high density distribution area movement displacement calculating unit, and the information distribution means (c) includes an information distributing unit (c-1) of a high density distribution area prediction type, which information distributing unit selects information corresponding to the destination of movement, predicted by the high density distribution area movement predicting unit (b-2), and distributes the selected information.

As another preferred feature, the information distribution means (c) includes: a distance/arrival time estimating unit (c-2) which estimates the distance and/or the time required to move from the high density distribution block to a place where the information distribution requester is located or a place specified by the information distribution requester, based on the calculation result obtained by the high density distribution area movement displacement calculating unit (b-1); and an information distributing unit (c-3) of a distance/arrival time estimation type, which information distributing unit distributes information corresponding to the distance and/or the arrival time estimated by the distance/arrival time estimating unit (c-2) to the mobile information terminals within the high density distribution area.

As yet another preferred feature, the information distributing means (c) includes a distribution information recommending unit (c-4) which makes recommendations with respect to to-be-distributed information corresponding to the distance/arrival time estimated by the distance/arrival time estimating unit (c-2) or includes a high-density distribution area movement prediction result notifying unit (c-5) which notifies the information distribution requester's terminal of the prediction result obtained by the high density distribution area movement predicting unit (b-2).

As a further preferred feature, the server system includes a user reaction processing means (d) which analyzes reaction of the service users' mobile terminals to information distributed from the information distributing means (c), and then outputs the analysis result to an external apparatus.

As a still further preferred feature, the distribution state predicting means (b) includes an approximation function estimating unit (b-3) which predicts the distribution state by estimating an approximation function with respect to change over time in the future distribution state based on a history of monitoring result in the past obtained by the distribution state change monitoring means (a). In this case, the server system preferably includes a movement prediction data providing means (e) which provides the information distribution requester's terminal with information corresponding to the estimation result obtained by the approximation function estimating unit (b-3) as movement prediction data of the service users.

As a generic feature, there is provided an information distribution method for an information distribution service providing system which includes: a server system which provides a plurality of mobile information terminals, carried by a plurality of users who have been registered as users of information distribution service, with the information distribution service via a communication network; and a terminal of an information distribution requester, which terminal communicates with the server system and specifies user property and information distribution object areas for the users to whom information is to be distributed by the information distribution service, the method comprising: on the server system,

(a) monitoring change over time in distribution of the mobile information terminals of the users with the user property in the information distribution object area, based on location information of the mobile information terminals;

(b) predicting a distribution state of the mobile information terminals in the future based on the monitoring result; and

(c) distributing information to the mobile information terminals of the service users based on the prediction result.

As a preferred feature, the server system performs the following: calculating distribution density of mobile information terminals of the service users with the user property in a specified block included in the information distribution object area, based on location information of the mobile information terminal; detecting a high density distribution area, in which the distribution density is higher than a predetermined density, based on the calculation result; calculating movement displacement of the high density distribution area; predicting a destination to which the high density distribution area moves, based on the thus-obtained movement displacement; and selecting information corresponding to the destination of movement predicted, and distributing the corresponding information.

As another preferred feature, the server system performs the following: estimating the distance and/or the time required to move from the high density distribution area to a place where the information distribution requester is located or a place specified by the information distribution requester, based on the movement displacement obtained by the above-mentioned calculation; and distributing information corresponding to the distance and/or the arrival time estimated to the mobile information terminals within the high density distribution area.

As yet another preferred feature, the server system makes recommendations with respect to to-be-distributed information in accordance with the thus estimated distance and/or arrival time to the terminal of the information distribution requester. The server system preferably notifies the information distribution requester's terminal of the result of prediction about a destination of the high density distribution area.

As a further preferred feature, the server system analyzes reaction of the service users' mobile terminals to information distributed to the service users' mobile terminals based on the distribution state prediction result, and then outputs the analysis result to an external apparatus.

As a still further preferred feature, the server system predicts the distribution state by estimating an approximation function with respect to change over time in the future distribution state based on a history of monitoring result in the past distribution state. In this case, the server system preferably provides the information distribution requester's terminal with information corresponding to the approximation function as movement prediction data of the service users.

Furthermore, the server system for use in the information distribution service providing system of the present invention has the equivalent construction to that of the server system included in the present information distribution service providing system.

### BRIEF DESCRIPTION OF THE DRAWINGS

FIG. 1 is a conceptual view of an example of an information distribution service providing system to which the present invention is applied;

FIG. 2 is a view for describing the concept of an object area of information distribution service according to the present embodiment;

FIG. 3 is a view for describing the concept of a unit area and a distribution spot according to the present embodiment;

FIG. 4A and FIG. 4B are views each for describing a concept of an area in which distribution density calculation is performed with priority with respect to an information distribution area according to the present embodiment;

FIG. 5 is a functional block diagram showing a construction of a server system (ASP) of FIG. 1 with attention paid to a user service registration processing function;

FIG. 6 is a functional block diagram showing a construction of an ASP of FIG. 1 with attention paid to an information provider registration processing function;

FIG. 7 is a functional block diagram showing a construction of an ASP of FIG. 1 with attention paid to a map information management function;

FIG. 8 is a functional block diagram showing a construction of an ASP of FIG. 1 with attention paid to ASP operation management/specified area processing functions;

FIG. 9 is a functional block diagram showing a construction of an ASP of FIG. 1 with attention paid to a function of making more accurate a distribution density calculation priority area;

FIG. 10 is a functional block diagram showing a construction of an ASP of FIG. 1 with attention paid to a high-density distribution spot appearance state (movement displacement) evaluating function;

FIG. 11 is a functional block diagram showing a construction of an ASP of FIG. 1 with attention paid to a distribution density time-series change recording and predicting function;

FIG. 12 is an image view of an area which is specified by an information provider according to the present embodiment;

FIG. 13 is a table indicating an example of recorded contents of the time-series density change recording data base (DB) of FIG. 11;

FIG. 14 is a graph indicating change in density with respect to time for describing the approximation function estimation method for density change in an area specified by the information provider according to the present embodiment;

FIG. 15 is a functional block diagram showing a construction of an ASP of FIG. 1 with attention paid to an information distribution processing function of the ASP;

FIG. 16 is a functional block diagram showing a construction of an ASP of FIG. 1 with attention paid to a user reaction processing function of the ASP;

FIG. 17 is a functional block diagram showing a construction of an ASP of FIG. 1 with attention paid to an information provider response processing function of the ASP;

FIG. 18 is a functional block diagram showing a construction of an ASP of FIG. 1 with attention paid to a distribution information request processing function;

FIG. 19 is a flowchart for describing an elaboration process of an area in which distribution density calculation is performed with priority according to the present embodiment;

FIG. 20 and FIG. 21 are views each for describing a method for setting a distribution density calculation priority area according to the present embodiment;

FIG. 22 is a flowchart for describing an evaluation process of the appearance state (movement displacement) of high-density distribution spots according to the present embodiment;

FIG. 23 is a conceptual view for describing a method for setting a movement displacement prediction area according to the present embodiment;

FIG. 24 is a flowchart for describing an information distribution process within an area in which distribution density calculation is performed with priority according to the present embodiment;

FIG. 25 is a conceptual view indicating movement of a high-density distribution spot according to the present embodiment;

FIG. 26 through FIG. 28 are views each for describing a business application of the information distribution service by the ASP of the present embodiment;

FIG. 29 is a block diagram showing an important part of a construction of a restaurant operation system, which diagram is for describing an example of a business application of the ASP information distribution service according to the present embodiment;

FIG. 30 is a sequence view for describing an example of a business application of the ASP information distribution service according to the present embodiment;

FIG. 31 through FIG. 34 are sequence views each for describing settlement processing in the ASP information distribution service of the present embodiment; and

FIG. 35 is a diagram for describing a process of setting a distribution density calculation priority area according to the present embodiment.

### DESCRIPTION OF THE PREFFERED EMBODIMENT(S)

[A] System Overview

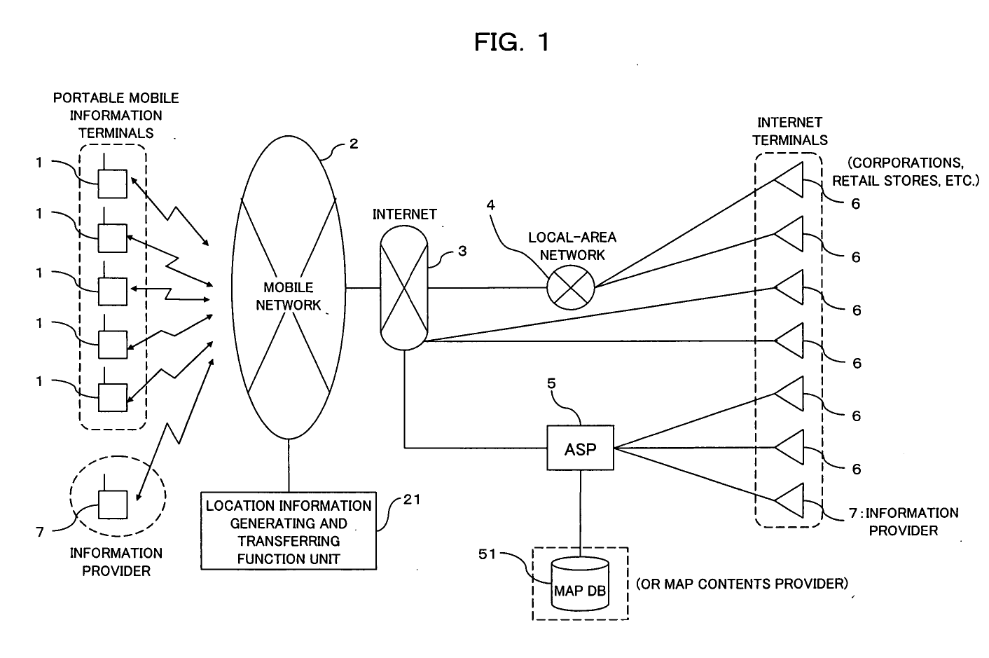

FIG. 1 is a conceptual view of an example of an information distribution service providing system to which the present invention is applied. The information distribution service providing system (hereinafter sometimes simply called an information distribution system) of FIG. 1 includes: portable mobile information terminals 1 which are carried by users of the present information distribution service; a mobile network (public mobile communication network) 2; the Internet 3; a local-area network 4 (such as an enterprise network); a server system 5 of Application Service Provider (ASP); fixed terminals (Internet terminals) 6 such as personal computers; a terminal (Internet terminal or portable mobile information terminal) 7 of an information provider which provides distribution information which is distributed by the present information distribution service.

Here, each portable mobile information terminal 1 (hereinafter also simply called a “mobile terminal 1” or a “terminal 1”) has a voice communication function and a data communication function in the mobile network 2, and it is also equipped with a function as an Internet connection terminal [a function of accessing the WWW (World Wide Web) including text data, static image data, motion picture data, sound data, and music data, and functions of displaying/replaying of sound signals/transceiving of e-mail]. Such mobile terminals 1 include mobile phones, but should not be limited to those. For example, any equipment having a communication function and a display function separately can also be included.

Further, the mobile network 2 is an access network to which the mobile terminals 1 are connected when they carry out communications. When the mobile terminals 1 transceive data to/from the Internet 3, the mobile network 2 has a function of relaying the data. Further, the mobile network 2 has a terminal 1's location information generating and transferring function unit 21. This function unit 21 provides (notifies) the server system 5 with the location information of the mobile terminals 1. This location information generating and transferring function unit 21 can be provided as one of the functions of the mobile network such as a location information center or the like, or alternatively it can be installed in the mobile terminals 1 as a GPS (Global Positioning System) function or the like. Here, “location information” is information for identifying locations with adequate accuracy for providing service, and the longitude and the latitude exemplify such location information.

The Internet 3 is a communication network in which data is transceived under TCP/IP (Transmission Control Protocol/Internet Protocol). The mobile terminals 1 or the terminal 7 (hereinafter sometimes called the “information provider 7”) which belongs to an information provider (information distribution requester) are connected to the Internet 3, whereby it becomes possible for the mobile terminals 1 and the terminal 7 to transceive information with various servers and other terminals.

The local-area network 4 is a communication network, such as intranet, constructed by Internet terminals 6 belonging to a company or a retail shop. The local-area network 4 is connected to the Internet 3, whereby it becomes possible for the Internet terminals 6 to transceive information with various servers and other terminals than those in the local-area network 4 via the Internet 3.

The server system 5 (hereinafter described as “ASP5”) is one of the constituents of the Internet 3, and has all the common functions of an Internet server, and has various processing functions for realizing the information distribution service of the present invention. The ASP 5 is capable of providing each mobile terminal 1 registered for information distribution service with information corresponding to the location of the mobile terminal 1 via the Internet 3 and the mobile network 2.

Here, the present ASP 5 also has a map data base (DB) 51. On the basis of the map information held in the map data base 51 and the location information of the mobile terminal 1, calculation of the distribution density of the mobile terminals 1 in a specific area is carried out. In this instance, the map DB 51 can be supplied to the ASP 5 from a map content provider based on a contract with the provider.

Further, the information provider is a company, an organization, or an individual person who intends to distribute information to users of the present information distribution service who have mobile terminals 1. The information provider uses the terminal 7, which has an information processing function and an information input function necessary for communication with the ASP 5, to communicate with the ASP 5 via the Internet 3, the mobile network 2, or local-area network 4, to specify the property (user property) of the user to whom information is to be distributed and information distribution object areas. Here, “the property of a service user” includes the category of information the user wants to receive and information relating to a service user, such as gender, age, fields of interest, etc.

With the above basic system construction, the present embodiment not only distributes information in a predetermined region (area) at a predetermined time, but also performs the following. The present embodiment (1) acknowledges (monitors) time-series change in the distribution state (density) of the mobile terminals 1 of service users at a certain time point, to understand the movement of the mobile terminals 1 of users as a group. As a result, it becomes possible to predict the movement of the group. Then, an appropriate time (several minutes to several hours) before the time when a lot of users gather at a certain location, advertisement information corresponding to the certain location is distributed to an area in which users who are expected to gather to the above location are present. In addition, such advertisement information distribution can be proposed (recommended) to the information provider 7 (efficient advertisement can be carried out). Further, the present embodiment (2) quantitatively (to some degree) evaluates change in movement caused by the information distribution in the group of mobile terminals 1, and the resultant data is incorporated into future service to be provided to the information provider 7.

Further, according to the present embodiment, on the basis of the above evaluation method, it is possible to give the information provider 7 advice on areas to which information is to be distributed and on the contents of the to-be-distributed information. This service can be provided on a chargeable basis. In summary, the information distribution service of the present invention is useful as a tool for analyzing the market.

Such a service is advantageous to the information provider 7 in that information distribution services, such as advertisement information, in which financial rationality and cost performance are improved, are provided. In contrast, to users of the information distribution service, the present embodiment is advantageous in that information distributed to the users is highly valid and persuasive.

For example, an estimation is made on whether people who are moving from Yokohama in a north easterly direction are going to the Shibuya are (North West region) or the Yuraku-cho area (North East region). Information about Shibuya is distributed to people who are going to the Shibuya area, and information about Yuraku-cho and Ginza is distributed to people who are going to the Yuyaku-cho area. Accordingly, effective advertisement can be expected on the information provider side, and appropriate and useful information can be expected on the user side.

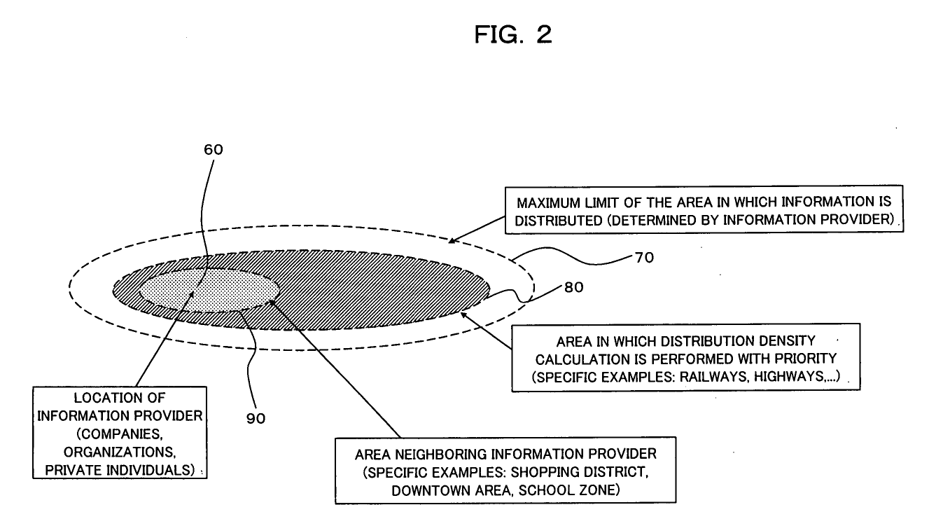

Hence, in the present embodiment, as shown in FIG. 2, within the maximum limit area 70 for information distribution, which limit area 70 is determined by the information provider 7 (retail shops, companies in the distribution industry, and organizations and associations such as event planning companies and individual persons) with respect to their location 60, the area (area) 80 which is present within the limit area 70 and in which change in the distribution density of mobile terminals 1 with user property as distribution objects and whose movements are to be evaluated and estimated, is determined. On the basis of the evaluation and estimation result, an area [for example, the neighboring area (shopping street, downtown, school zone) of the location 60 of the information provider] smaller than the maximum limit is determined to be a practical distribution object area 90, and information is distributed to the area 90.

As a result, the main procedures of information distribution service of the present embodiment are formed by the following four Phases.

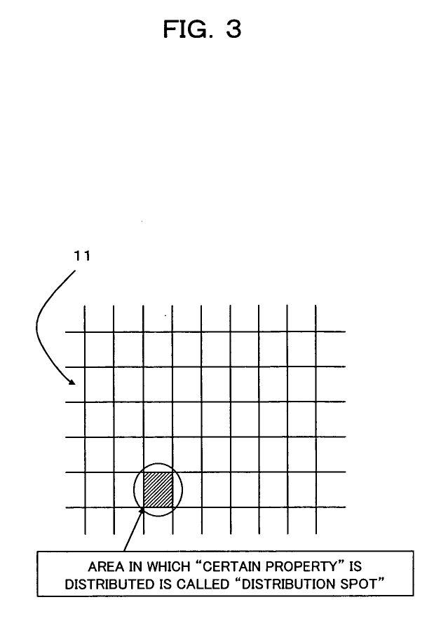

First Phase: location information of each mobile terminal 1 is acknowledged, and distribution density (terminal distribution density) of mobile terminals 1 in each unit block or in each basic block, formed by an appropriate number of unit blocks, is calculated at predetermined time intervals. Here, the “unit block” means an area as a unit for acknowledging the location of each terminal 1. For example, as shown in FIG. 3, it means a basic minimum unit block 11 (a square with a latitude and a longitude of 10 seconds, 200 m in the north-south direction and 200 m in the east-west direction) determined by map information. An area in which users (mobile terminal 1) with certain characteristics are densely distributed is called a “distribution spot” (see the shaded area in FIG. 3).

Second phase: Areas (called “high-density distribution spot” or “high-density spot”) in which terminal distribution density is high in distribution object areas 70 and 80 for each information provider 7 is extracted.

Third phase: movement rules (movement route and movement speed) of the high-density spots are estimated.

Fourth phase: On the basis of the estimation result of the above third phase, information is distributed to a selected area which is appropriate as an object area at a certain time before an object time. In this instance, these are basically calculated for each property of the mobile information terminal 1.

The following is an example case in which the above information distribution service is applied.

It is assumed that the following tendency is found. At a certain period of time everyday, a lot of terminals 1 move toward shop A in a downtown area (for example, Kawasaki station road) by train. For example, at noon, the distribution density of terminals 1 becomes high in the proximity of shop A. Under this condition, at 11:00 a.m., shop A distributes the advertisement, “a sale for a limited time is being held at shop A in Kawasaki station road after one hour”, setting stations within a one-hour train ride as the information distribution area.

By using such an information distribution method, cost performance of the advertisement is improved for shop A, and the users of the terminals 1 receive only relevant information. Thus, the method is useful for both shop A and the users of the terminals 1.

The above example is based on the assumption that the ASP 5 has map information with which the railway map and the distribution of terminals 1 can be associated. The map information is provided by the map DB 51 or a map contents provider. That is, a spot in which terminal distribution density is high is along a railway and the ASP 5 decides that the spot is moving along the railway. For this purpose, accurate railway location information and accurate location information of the terminals 1 are necessary for comparison therebetween. The same applies to roads.

Since people move along railways or roads, the ASP 5 needs to have at least main railway and road information. Further, as to locations at which people gather, the ASP 5 needs to have information as accurate as the above railway or road information. However, even when the ASP 5 does not have such accurate information about roads and railways, it is not impossible to realize the above described service (the method will be described below).

In this instance, airplanes and ships are also main transportation means, but the present embodiment excludes them on purpose. In the present situation, movement routes by airplanes and ships cannot be acknowledged as accurately as roads and railways. In addition, high-density spots appear at random and infrequent intervals, so that the static processing of the present embodiment cannot be applied.

On the above assumption, the means for realizing the aforementioned first phase through fourth phase are constructed. Here, in the present embodiment, the following way of thinking is incorporated. That is,
(a) whether or not a certain area becomes a high-density spot regarding a certain property has nothing to do with the densities of the neighboring blocks (as a whole, the appearance, disappearance, continuation period of the high-density spot are independent phenomenon for each unit block).
(b) as to the appearance of a high-density spot by unit block or by basic block, a time-series rule can be found between neighboring unit blocks or between neighboring basic blocks with respect to the main roads and railways. As an example of a typical pattern, on weekday mornings at commuter time, people move from residential areas to office areas along railways and roads. At that time, rules are found to be defined by the following procedures.

In the following, the concept of the above first phase through fourth phase will be described.

(1) As to the First Phase:

The method with which the ASP 5 acknowledges the location information of the mobile terminal 1 is publicly known (for example, see the above patent document 1, and Nikkei Communication, Jan. 20, 2003, pp 130 through 131, “Mechanism of 3G mobile telephone”). Thus, the publicly known method is applied. For example, when terminals 1 are capable of measuring locations of their own by using their GPS function as a location information generating and transferring function unit 21, the location information can be transmitted from the mobile terminals 1 to the ASP 5. Even when mobile terminals 1 do not have a location measuring function of their own, identification information of a basic station in a mobile network 2 can be sent to the ASP 5 as location information of the terminals 1.

Further, as to a method for calculating the distribution density of the mobile terminals 1, a technique similar to the technique disclosed in Japanese Patent Application Laid-open No. 2003-089499 can be applied. That is, the ASP 5 keeps obtaining the location information of terminals 1 (hereinafter all so called users 1) of service users from all the service (information distribution object) area, and records the obtained information in association with unit block (or basic block). Since the areas of the unit block and basic block can be easily calculated, it is possible to calculate the distribution density.

(2) As to the Second Phase:

Since the areas of all of the unit blocks and the number of terminals 1 present in the blocks are acknowledged in the above first phase, it is possible to calculate the distribution density. For example, more than one unit block is incorporated to form an area which is appropriate to density determination. The incorporation is performed so as to match the predetermined condition (information distribution area 70 determined as the maximum limit by the information provider 7). In the incorporated areas, distribution density is obtained for the properties specified by the information provider 7. The ASP 5 selects the threshold to be applied to each area, to decide whether or not the area is a high-density area. If the area is decided to be a high-density area, the area is stored together with relevant information such as time information.

(3) As to the Third Phase:

By the above second phase, it is possible to extract high-density spot groups at appropriate time intervals. These are stored during a certain time duration, and the ASP 5 evaluates the tendency of appearance of high-density spots in the area in which distribution density is to be evaluated with priority, to estimate the rules of movement of high-density spots.

For example, patterns of movement rules are prepared beforehand, and it is evaluated whether any of the patterns hold true to find a pattern which the current pattern matches (correlation is high). If there is no pattern with which the current pattern matches, it is decided that the spots are not moving.

(4) As to the Fourth Phase:

By the above third phase, the movement pattern of the high-density spot can be selected. Using the selected movement pattern, the ASP 5 notifies the information provider 7 of the following information.

For example, it is assumed that, as a movement pattern of a high-density spot, the pattern that “if a high-density spot exists near JR Yokosuka station on the morning of a holiday, the high-density spot will move to JR Kawasaki station one hour later” is found. Later, the ASP 5 evaluates the state of appearance of high-density spot in the morning of a holiday, and then if a high-density spot is recognized near JR Yokosuka station, the ASP 5 sends advice to shop A near JR Kawasaki station.

The following is a conceivable advice example: “a lot of potential customers are now near JR Yokosuka station, and it is highly likely that they will move to JR Kawasaki station one hour later. It is recommended that a sale for a limited time be held one hour later, and that its advertisement be distributed within the area near JR Yokosuka station”.

Here, appropriate information should be selected and created depending on the business (eating place or clothing shop, etc.) of the information provider 7, which is a customer of the ASP 5, and on the movement pattern of the high-density spot.

To realize the above-described service, of high-density spots which repeatedly appear and disappear approximately at random over time, meaningful movement patterns should be ascertained.

The following is an outline of the way of thinking to find out the patterns.

In the beginning, a method for finding a movement pattern when high-density spots have been identified will be described.

(a) An area (for example, 23 wards in Tokyo) is divided into an appropriate particle size (for example, squares with a side of 100 m/200 m/500 m/1 km/2 km/5 km). Areas (areas) in which distribution density is high=high-density areas (spots) are identified at appropriate time intervals [for example, (1 minute/3 minutes/5 minutes/10 minutes/30 minutes/1 hour) depending on the characteristics of service].

(b) It is assumed that high-density area (spot) identifying time is expressed by tᵢ (i=0,1,2, . . . ). Of high-density areas (two or more) during a continuous time period of tᵢ₋ⱼ, tᵢ₋ⱼ₊₁, tᵢ₋ⱼ₊₂, . . . , tᵢ₋₂, tᵢ₋₁, if there are high-density areas matching each time or if there are high-density areas which do not match but are close to each other, the areas are regarded as one group (series). In this instance, the time interval of the identification time ti is determined depending on the characteristics of service (for example, 1 minute/3 minutes/5 minutes/10 minutes/30 minutes/1 hour).

(c) From each system, a data series which expresses the location of the spot =location information arrangement is extracted. Regarding a certain spot series, corresponding to each ti, is expressed as (xi, yi)(i=0, 1, 2, . . . ) (a coordinate system can be suitably determined, but using, for example, the longitude and the latitude, the origin should be appropriately determined).

(d) When the current time is tₙ, m-number of elements (tₙ₋ₘ₊₁, tₙ₋₁, tₙ) are extracted from a certain spot series of location information arrangement. Using the data, a movement prediction continuous curve of a spot is estimated. As the most simple way, using tₙ and tₙ₋₁, linear approximation is performed. Alternatively, as a trail path estimation method, arbitrarily known methods are available.

(e) After obtaining the prediction curve of the trail path, the mean movement speed is estimated from the location information arrangement. Based on the movement speed and the prediction curve of the trail path, the location of the spot after elapse of an arbitrary time period can be estimated. In this instance, if the movement speed is equal or lower than a set value, or if the movement direction of the location information arrangement at each time is close to random, a rather wider area containing the spot can be used as a prediction location.

(f) By estimating the trail path and the movement speed at an interval of ti, the time when a spot arrives at a place can be estimated at a certain time. In this instance, in the above example, the location is expressed by the orthogonal coordinate system, it can alternatively be expressed by the polar coordinate system. The latter is sometimes suitable for understanding the direction of movement.

(Practical Means for Identifying a High-Density Spot)

As a method for identifying spots in which terminals 1 are densely distributed, the above-described method can be theoretically performed with respect to the whole service object (information distribution object) area. However, the above method aims at finding places where people gather, and thus places where people normally do not gather can be excluded from the object. For example, mountains and forests, fields and gardens, and dedicated residential areas can be excluded from the object areas. Taking an overview of the whole of Japan, people cluster in a few comparatively small areas. Thus, if places where people do not gather are included in the object area, computer resources and processing performance is wasted, thereby increasing service cost. If there is any special requirement by information provider 7 (sponsor), areas which are normally not monitored can be included as monitoring objects.

On the basis of the above reasons, places in which people are expected to gather for any reason, and transit systems to such places are monitored to be aware of changes in distribution density. Such places are, for example, downtowns, business areas, institutions ((soccer stadiums, baseball stadiums, golf clubs, other sports stadiums, theme parks, amusement parks, temples and shrines (seasonal events, such as hatsumoude, shichigosan, etc. are taken into consideration), sight-seeing spots such as places of scenic beauty and of historical interest, various types of schools [elementary schools, junior high schools, high schools, universities (entrance examination)], various halls where seminars, etc., are held, accommodations (large-scale hotels)}, and main streets and roads, railways and stations (including bridges and tunnels) leading to the above spots. (A method for identifying high-density spots)

Various variations are conceivable as a result of combinations of methods for calculating the distribution density and thresholds for deciding density levels. How to obtain distribution density:

The following three levels are considered.

(1) System Basics

A unit block 11 (see FIG. 3) is determined as a unit for acknowledging the locations of terminals 1: for example, squares in 10-second latitude and 10-second longitude, having a side of 200 m in the north-south direction and a side of 200 m in the east-west direction.

(2) Areas and Blocks (Basic block) for Deciding Density

The shape and the size of each block is set appropriately (thresholds which will be described later should be also changed), paying consideration to the characteristics of the object areas and the object events (for example, the Soccer World Cup final, throwaway baseball matches at the end of the season, Hatsumoude (new-year first visit to a shrine; a big event in Japan), entrance examinations of a popular university, theme parks in local cities, highways, and railways). This is because the following is taken into account. Taking a sight-seeing spot in a mountainous region as an example, when people gather therein, the people are fewer than people gathering in downtown of a big city. If the decision is made using the same standard for the two cases, the sight-seeing spot cannot be decided to be a “high-density spot”. Thus, the above-described (1) unit blocks are combined, and the density is calculated by “the number of terminals÷the area”.

In this instance, the distribution density D_{A}(X) of the user property A in the region X is obtained by D_{A}(X)=[the number of users with user characteristic A present in the region(X)]÷[the area of the region (X)]. Further, the distribution density D_{A}(Xᵢ) (i=1 through m) of user characteristic A in the unit blocks X₁, X₂, . . . , Xₘ included in the region X is obtained by D_{A}(Xᵢ)=[the number of users with user characteristic A present in the unit block (Xᵢ)]÷[the area of the unit block (Xᵢ)]. Here, the area of X₁ through Xₘ should be adequately smaller than the area of X.

(3) Object Region Specified by Information Provider 7

The information provider 7 makes a contract with the ASP 5 for monitoring a certain service area. This area normally covers the catchment area of the information provider 7, which is a retail shop. The ASP 5 evaluates whether or not the service object area is a high-density spot for each of the above objects (2), based on the data of unit block of the above (1), according to the way of thinking of threshold appropriately determined (detailed later).

Here, on the highway, etc., the following way of thinking should be incorporated, thereby improving decision accuracy.

That is, if the above unit block of the above (1) is assumed to be 200 m×200 m, the unit block is too broad to accurately decide the distribution density of the terminals 1 on the highway. Assuming that the width of Japanese highways is formed by four lanes in both directions, the highways have a width of at most approximately 40 m. Accordingly, if it is decided that the terminals 1 are located on any highways, the area of the highways which occupies in the unit block is comparatively small. Here, “the density on the highway” needs to be obtained, but use of the unit block will bring about deviation from the real value. Therefore, as an area in which distribution density calculation is to be performed with high priority, the area of the road portion in the unit block is obtained previously, and using the thus obtained area, the density calculation is performed, thereby realizing the density close to the practical value. In this instance, when the size of the unit block is made sufficiently small in comparison with the width of the highway, if more than one unit block is combined to cover the highway, the error does not become large. Thus, this is also applicable.

On the other hand, taking an example where change in the distribution density of the terminals 1 is monitored in each unit block in an area with some width, such as downtown, high density spots appear and disappear repeatedly (when a number of people are moving at random in the area). In such a case, a basic block which is made of two or more unit blocks is defined, and it is decided whether or not the density of the basic block is high. As such methods, for example, there are (a) a method for making a decision based on the average density in the basic block (the whole of an area), and (b) a method for making a decision based on whether or not high-density spots equal to or exceeding a threshold value in number continuously exist in the basic block (effective when the density is locally high but the average density is low).

A Concept of Threshold:

As an extreme example, (a) in a certain downtown area, people are always moving therein except for at midnight and early in the morning, and thus the distribution density is high on average. To decide the area as a “high-density spot”, a density exceeding an average density to some degree is set as a threshold. However, in special cases in which comparatively high-density spots are monitored in a broad area, threshold can be uniform.

Further, (b) on highways, a narrow area covering a highway should be an object. The following three situations should be identified: (b1) when the highway is almost empty (distribution density is close to zero); (b2) traffic is moving smoothly (the absolute value of the density is small, but the density is relatively high as on a highway; (b3) traffic is jammed (the absolute value of the density is not so high, but the density is high as on a highway). The threshold value for the above identification is significantly lower than the threshold value in the above case (a).

From the above conditions, and from the information provider 7's request, the threshold value used to decide whether or not the density is high or not is appropriately changed.

(Method for Identifying the Movement of a High-density Spot)

Assuming that there are three high-density spots A₀, B₀, and C₀ at time T₀, and that there are three high-density spots A₁, B₁, and C₁, at time T₁, when a decision is made, if A₀ and A₁, B₀ and B₁, and C₀ and C₁, exist at almost the same locations, it is impossible to evaluate whether or not spot B₀ has moved to A₁, B₁, C₁ (or another, more distant location) (or stood sill) by only using the locations of the high-density spots.

In such a case, some terminals 1 existing in spot B₀ are sampled at random, or the locations of all the terminals 1 at time T₀ and T₁ are compared, to acknowledge in which of the spots A₁, B₁, and C₁ the terminals exist, whereby the movement of the high-density spots are evaluated.

(Definition of Map Information Assumed in the Present Embodiment)

In the present embodiment, knowledge information (information about places where people cluster and a means of transportation) for use in extracting object areas for monitoring the distribution density therein is incorporated in the ASP 5 at the time point when the initiation of the service by the ASP 5 in a form which is identifiable to a computer system. Such knowledge information is updated as necessary according to change in circumstance (for example, a new large-scale office building is built; a theme park is newly opened/closed; a railway service is started/abandoned; a station is newly opened/closed; the number of lanes is increased/decreased; an interchange is opened/closed) or information demanded.

That is, the ASP 5 divides a service supply object area into unit blocks (or basic blocks) appropriate in size and identifiable by an appropriate method. In such blocks, for example, downtowns, business areas, institutions {(soccer stadiums, baseball stadiums, golf clubs, other sports stadiums, theme parks, amusement parks, temples and shrines (seasonal events, such as hatsumoude, shichigosan, etc. are taken into consideration), sight-seeing spots such as places of scenic beauty and of historical interest, various types of schools [elementary schools, junior high schools, high schools, universities (entrance examinations)], various halls where seminars, etc., are held, accommodations (large-scale hotels)}, and main streets and roads, railways and stations (including bridges and tunnels) leading to the above spots, are included. The ASP 5 has information beforehand about where in the divided blocks the above various types of places and objects exist. If such a place or object is included in two or more divided blocks, the ASP 5 includes information about which unit blocks cover the place or the object. If any other place or object is included in the above place or the object is included in two or more divided areas, the ASP 5 includes information for identifying such an inclusion relationship or a means for inputting such information later as necessary (for example, manually inputting).

In recent digitalized maps, various types of information are included in a hierarchical manner, and roads and railways constitutes a level of the hierarchy. Railway data is included as data of a row of vectors. Further, if data is lacking, it is possible for the ASP 5 itself to supplement the data, so that if the above-mentioned condition is provided in the present embodiment, it is sufficiently rational. Here, even in cases where information about roads and railways are insufficient and only data of main points of the roads and railways is held, the present embodiment can be applied by using a method of limiting a monitoring area of density change, as described below.

[B] Concrete Example of Server System

Now, a description will be made of a concrete example of the ASP 5 to which the present invention is applied.

(B1) User Service Registration Processing Function

To use the information distribution service of the present invention, users need to be registered beforehand to the ASP 5. Its procedures are publicly known, and the procedures disclosed in the above patent document 1, for example, can be applied.

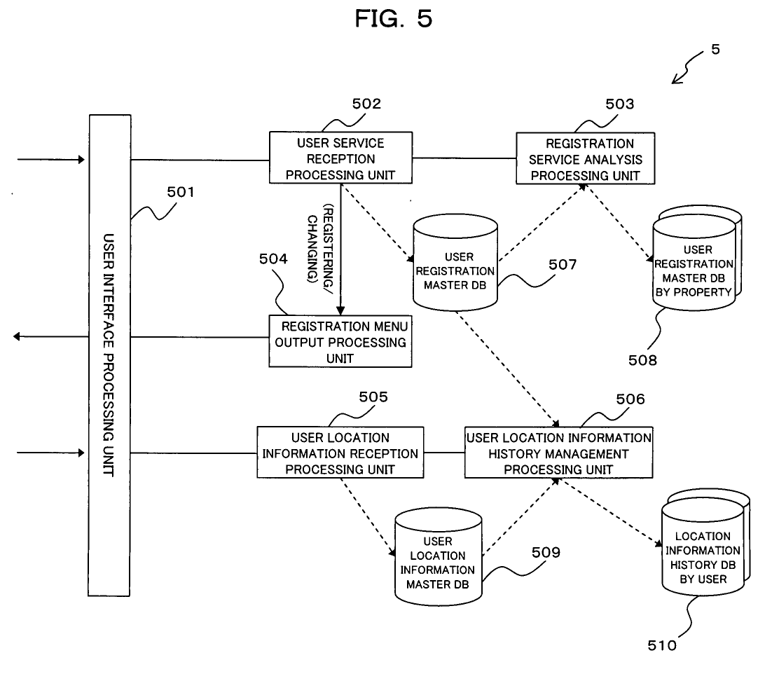

For this purpose, the ASP 5 of the present embodiment, as shown in FIG. 5, has the following functions as user service registration processing functions: (1) a function of making a user register information (user property) about user characteristics and fields of interest, which are necessary for distinguishing types of distribution information to be distributed to a user of the terminal 1 which is registered for use of information distribution service of the present invention, on user's agreement; (2) a function of accepting “new registration”, “updating”, “initiation”, “temporal halting”, and “canceling” of service, from a service user; (3) a function of accepting update of the user property information which has been registered by a user and user registration information, processing such information, reserving the information appropriately, and managing the information; and (4) a function of storing the location information of a service user of the present information distribution service, reserving the displacement of the location information of the users, and managing the location information.

That is, as shown in FIG. 5, the ASP 5 includes: a user interface processing unit 501; a user service reception processing unit 502; a registration service analysis processing unit 503; a registration menu output processing unit 504; a user location information reception processing unit 505; a user location information history management processing unit 506; a user registration master DB (database) 507; user registration master DBs 508 by property; a user location information master DB 509; and location information history DBs 510 by user.

Here, the user interface processing unit 501 is for communicating various types of information with a service use of the mobile terminal 1. Through this user interface processing unit 501, the location information generating and transferring function unit 21 receives the location information of a service user which is sent from the terminal 1 from moment to moment, or which is sent from the terminal 1 in accordance with an instruction of the ASP 5.

The user service reception processing unit 502 accepts a request sent from the terminal 1, and evaluates the contents of the request (new registration for service use, updating, temporal halting; initiation; canceling, and etc.), and performs processing corresponding to the request contents (instruction to send “registration menu” to the registration menu output processing unit 504, and rewrite/delete the contents of the user registration master DB 507), and accepts registration contents from the user (terminal 1).

The registration service analysis processing unit 503 analyzes the user registration contents accepted by the user service reception processing unit 502, and stores and records the registration contents in the user registration master DBs by property 508, which are separately provided by user property.

Further, the registration menu output processing unit 504 sends “registration menu” (information which lists characteristics and asks a user to make a selection from the characteristic), in which registration contents such as distribution demands are indicated, to the user terminal 1 via the user interface processing unit 501.

The user location information reception processing unit 505 regularly accepts the location information of the user terminal 1, and stores and records the information in the user location information master DB 509.

The user location information history management processing unit 506 stores and records the history of location information accepted by the user location information reception processing unit 505 in the location information history DB 510 by user.

In this instance, the user location information history management processing unit 506 performs unit block association so that calculation of data representing the distribution state (will be described later) becomes easy, and calculates the movement speed and direction, and the movement distance. The user location information history management processing unit 506 also properly categorizes and processes the same, and then stores the results in the location information history DB 510 by user.

That is, in order to realize the above-mentioned user service registration processing function, the ASP 5 of the present embodiment has the following means.

(1) To use the present information distribution service, or to change the registered contents or the operation state, a means for sending, to the terminals 1 connected to the ASP 5, information to ask a user to select from a list of characteristics or operations, and to receive response information corresponding to the above and store the information (the registration menu output processing unit 504, the user service reception processing unit 502, the registration service analysis processing unit 503, the user registration master DB 507, and the user registration master DBs 508 by property);

(2) a means for categorizing the information received from the mobile terminal 1 into appropriate types, and storing only the latest information for each type or with a past history inclusive (the registration service analysis processing unit 503 and the user registration master DBs 508 by property);

(3) a means for receiving the location information which is generated at the terminal 1 or at a location information center or the like in the mobile network 2 and is sent from moment to moment (or sent in response to an instruction from the ASP 5) by means of the location information generating and transferring function unit 21 and for storing the location information with relevant information such as a time (user location information reception processing unit 505 and user location information master DB 509);

(4) a means for associating the location information of a service user with a unit block (or basic block) for making it easy to calculate the data representing the distribution state, and for calculating the movement speed per unit time and the movement direction, and for categorizing and processing the calculation results properly, and for recording the result (the user location information history management processing unit 506 and the location information history DB 510 by user).

In the ASP 5 with the above-described arrangement, the user interface processing unit 501 communicates information with the terminal 1, and the contents of the received information is evaluated by the user service reception processing unit 502. In the case of a new “registration”, when a request from a user (terminal 1) is to be newly registered as a service user, the user service reception processing unit 502 instructs the registration menu output processing unit 504 to send to the user terminal 1 a “registration menu” indicating registration contents such as a distribution request via the user interface processing unit 501.

Referring to the “registration menu” received from the ASP 5 and displayed on the screen of the terminal 1, the service user selects or inputs categories of information the user wants to receive, and the user's characteristic information, such as gender, age, fields of interest, and sends the registration information to the ASP 5. Upon receipt of the information, on the ASP 5, the user service reception processing unit 502 stores the received registration contents in the user registration master DB 507, and the registration service analysis processing unit 503 analyzes the registration contents and stores the contents in a user registration master DB 508 by property, which is separated based on the user characteristic.

On the other hand, if the user service reception processing unit 502 decides that a request from the user (terminal 1) is “updating” of the registration contents, as in the case of the above new registration, the registration menu output processing unit 504 sends the “registration menu” to the terminal 1 of the user. The user service reception processing unit 502 then receives new registration contents from the user. The user service reception processing unit 502 and the registration service analysis processing unit 503 rewrite and update the registration contents relating the user stored in the user registration master DB 507 and in the user registration master DB 508 by property, in accordance with the received new registration contents.

Further, if the user service reception processing unit 502 receives from a user a “canceling” request of the present information distribution service, the user service reception processing unit 502 and the registration service analysis processing unit 503 delete and erase information about the corresponding user in the user registration master DB 507 and the user registration master DB 508 by property.

In addition, if the user service reception processing unit 502 receives a “temporally halting” request for the present information distribution service from a user, the user service reception processing unit 502 and the registration service analysis processing unit 503 deactivate information about the user stored in the user registration master DB 507 and the user registration master DB 508 by property.

If the user service reception processing unit 502 receives an “initiation” request of the present information distribution service from a user, the user service reception processing unit 502 and the registration service analysis processing unit 503 activate information about the user stored in the user registration master DB 507 and the user registration master DB by property 508. In addition, the user location information reception processing unit 505 regularly receives the location information of the terminal 1 of the user and stores the location information in the user location information master DB 509, and the user location information history management processing unit 506 stores the history of locations of the user in the location information history DB 510 by user.

(B2) Information Provider Registration Processing Function

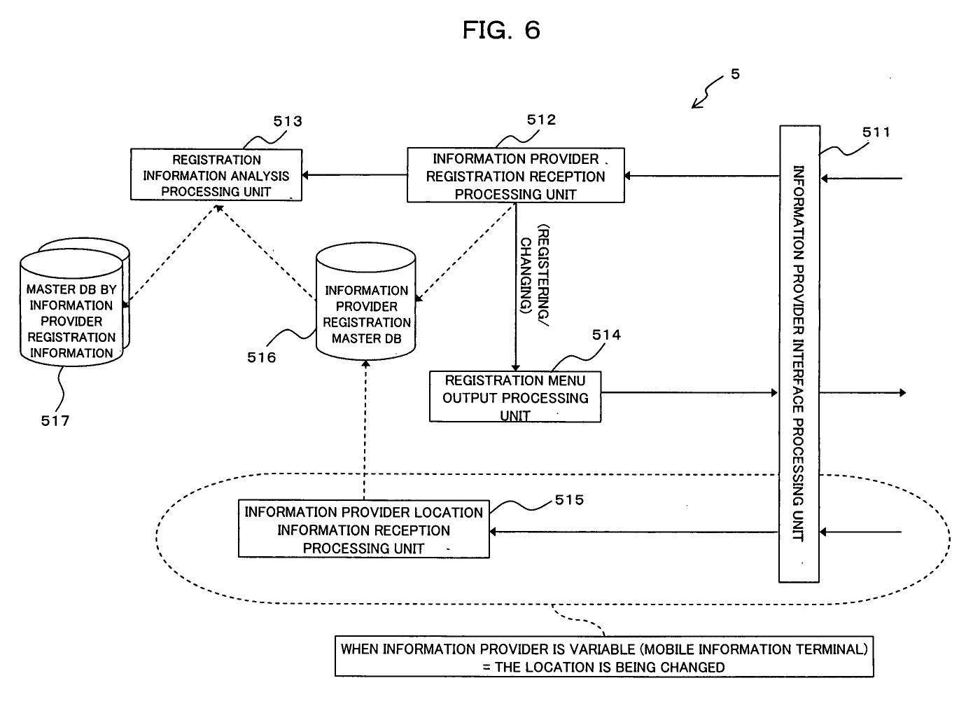

Information distribution service according to the present invention is on the assumption that the information provider 7 makes a contract for information distribution with the ASP 5. Thus, as shown in FIG. 6, the ASP 5 has the following information provider registration processing functions: (1) a function of making an information provider 7 register the following information by mutual consent: the location of the information provider 7; the sales location; information to be distributed; the profiles of users whom the information provider 7 expects the information distribution to affect; and distribution condition; (2) a function of accept “updating”, “temporally halting”, “canceling”, and “initiation” of the registration contents relating information distribution registered by the information provider; (3) a function of properly reserving the information of the information provider registered by the information provider 7 and updating of the distribution contents, and managing such information.

That is, as shown in FIG. 6, the ASP 5 includes: an information provider interface processing unit 511; an information provider registration reception processing unit 512; a registration information analysis processing unit 513; a registration menu output processing unit 514; an information provider location information reception processing unit 515; an information provider registration master DB 516; and a master DB by information provider registration information 517.

Here, the information provider interface processing unit 511 is an interface for communicating information with the information provider 7. The information provider registration reception processing unit 512 has a function of evaluating information contents received by the information provider interface processing unit 511 (including a request for information about the distribution state of user characteristics on which the information provider 7 expects good effects, such as increased sales, by information distribution in an area specified by the information provider 7 as information distribution target).

Further, the registration information analysis processing unit 513 analyzes the registration information received by the information provider interface processing unit 511 from the information provider 7, and stores the registration information in the master DB by information provider registration information 517 which is separated based on the distribution conditions. The registration menu output processing unit 514 sends a “registration menu”, in which registration contents such as distribution contents is shown, to the information provider 7 via the information provider interface processing unit 511.

In this instance, if the information received by the information provider registration reception processing unit 512 is a request for information about the distribution state of user property to which the information provider 7 expects good effects, such as increase in sales, the registration menu output processing unit 514 sends information indicating the distribution state of user properties, which are capable of being provided, to the information provider 7 connected to the ASP 5 as a list of options. The response information to the above is received by the information provider registration reception processing unit 512, and then stored in the information provider registration master DB 516.

Further, when an information provider performs service use registration from his/her mobile terminal 7 while moving, the information provider location information reception processing unit 515 regularly receives the location information of the terminal 7, and stores and records the latest location of the terminal 7 in the information provider registration master DB 516 . Here, the function of the information provider location information reception processing unit 515 can be omitted if the terminal 7 of the information provider is limited to a fixed terminal, not including a mobile terminal.

That is, to realize the above-mentioned information provider registration processing function, the ASP 5 has the following means:

(1) a means for sending information which is necessary for realizing service input from the information provider 7 connected to the ASP 5 or a list of options which is formatted so that the information provider 7 which is connected to the ASP 5 can select, and for receiving and storing the corresponding response information (information provider registration reception processing unit 512, registration menu output processing unit 514, and information provider registration master DB 516);

(2) a means for properly categorizing information which has been received from the information provider 7 connected to the ASP 5 and stored, into appropriate types, and for storing only the latest information for each type, or including the past history (registration information analysis processing unit 513, master DB by information provider registration information 517).

In the ASP 5 with the above arrangement, the information provider interface processing unit 511 communicates information with the information provider 7, and accepts “registration” for use of the present information distribution service, “updating” of the registered distribution contents, “initiation”, “temporally halting”, “canceling” of the use of service. The information provider registration reception processing unit 512 evaluates the contents of the received information.

As a result, if a request from the information provider 7 is, for example, a new “registration” for use of the present information distribution service, the information provider registration reception processing unit 512 instructs the registration menu output processing unit 514 to send out a “registration menu”, in which distribution contents and registration contents are shown, to the information provider 7 via the information provider interface processing unit 511.

Following the “registration menu”, the information provider 7 sends the location of the information provider 7, distribution information, and distribution condition (target areas to which information is distributed and its frequency), to the ASP 5. On the ASP 5, the information provider registration reception processing unit 512 stores the received registration contents in the information provider registration master DB 516, and the registration information analysis processing unit 513 analyzes the registration contents and stores the registration contents in the master DB by information provider registration information 517, which is separated by distribution condition.

On the other hand, if the request from the information provider 7 is “updating” of the registration contents, on the ASP 5, as in the case of the above-described new “registration”, the registration menu output processing unit 514 sends a “registration menu” to the information provider 7, and the information provider registration reception processing unit 512 accepts new registration contents from the information provider 7. The information provider registration reception processing unit 512 and the registration information analysis processing unit 513 store the accepted new registration information in the information provider registration master DB 516 and in the master DB by information provider registration information 517.

Further, if the request from the information provider 7 is “canceling” of the present information distribution service, on the ASP 5, the information provider registration reception processing unit 512 and the registration information analysis processing unit 513 cancel information about the corresponding information provider 7 in the information provider registration master DB 516 and the master DB by information provider registration information 517. Here, information is actually deleted after settlement of the service fee.

Still further, if the request from the information provider 7 is “temporally halting” of the present information distribution service, on the ASP 5, the information provider registration reception processing unit 512 and the registration information analysis processing unit 513 deactivates information about the information provider 7 in the information provider registration master DB 516 and the master DB by information provider registration information 517.

In addition, if the request from the information provider 7 is “initiation” of the present information distribution service, on the ASP 5, the information provider registration reception processing unit 512 and the registration information analysis processing unit 513 activate information about the information provider 7 in the information provider registration master DB 516 and the master DB by information provider registration information 517.

Further, if the information provider 7 performs operations such as service use registration, etc., using the terminal 1 he/she carries while moving, upon receipt of an “initiation” request for use of the present information distribution service, the information provider location information reception processing unit 515 regularly accepts the location information of the information provider 7, and the location information is stored in the information provider registration master DB 516 as the latest location of the information provider 7.

(B3) Map Information Managing Function

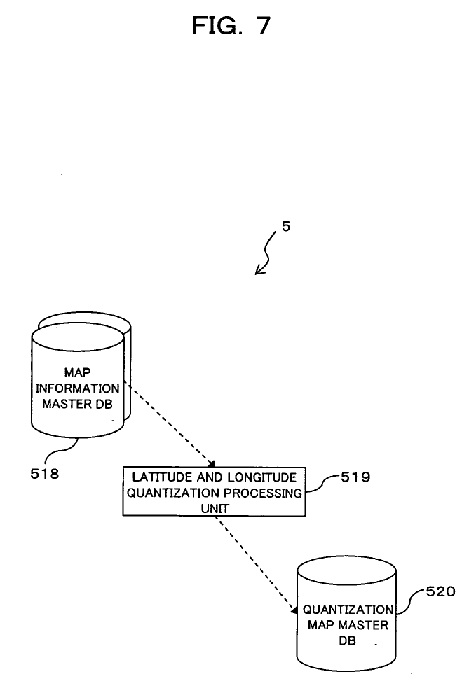

FIG. 7 is a functional block diagram showing a construction of an ASP 5 of the present embodiment with attention paid to a map information management function. As shown in FIG. 7, the ASP 5 has e.g., a map information master DB 518, a latitude and longitude quantization processing unit 519, and a quantization map master DB 520, as a map information managing function for associating an area specified as an information distribution object area with unit blocks of map information, and storing the area as a group of unit blocks.

Here, the map information master DB 518 stores and records various map information in a digital form. To associate the map information with the above-mentioned unit blocks, the latitude and longitude quantization processing unit 519 quantizes (for example, regarding the number below certain figures as zero) the latitude and the longitude. The quantization map master DB 520 stores and records the map information thus quantized by the latitude and longitude quantization processing unit 519 as map information which is applicable to the present information distribution service.

That is, the map information master DB 518, the latitude and longitude quantization processing unit 519, and the quantization map master DB 520 function as a means for dividing an area specified as an object area for information distribution into unit blocks in accordance with appropriate procedures. The above mentioned units also function as a means for expressing each unit block as a group of data whose area can be calculated and for calculating the area and storing the result.

With such a function, a specified area (service area) of the object of the information distribution service is associated with unit blocks of the map information. This association can be carried out by using another method than the above quantization method of the longitude and the latitude. For example, a certain area is divided into unit blocks and each of the blocks is given an identification number (publicly known method) (internationally, Marsden Square number is determined; in companies, a map code of Denso Corporation exists). In addition, Japanese Patent Application No. 2002-88432 also discloses such a method.

(B4) ASP Operation Management/Specified Area Processing Function:

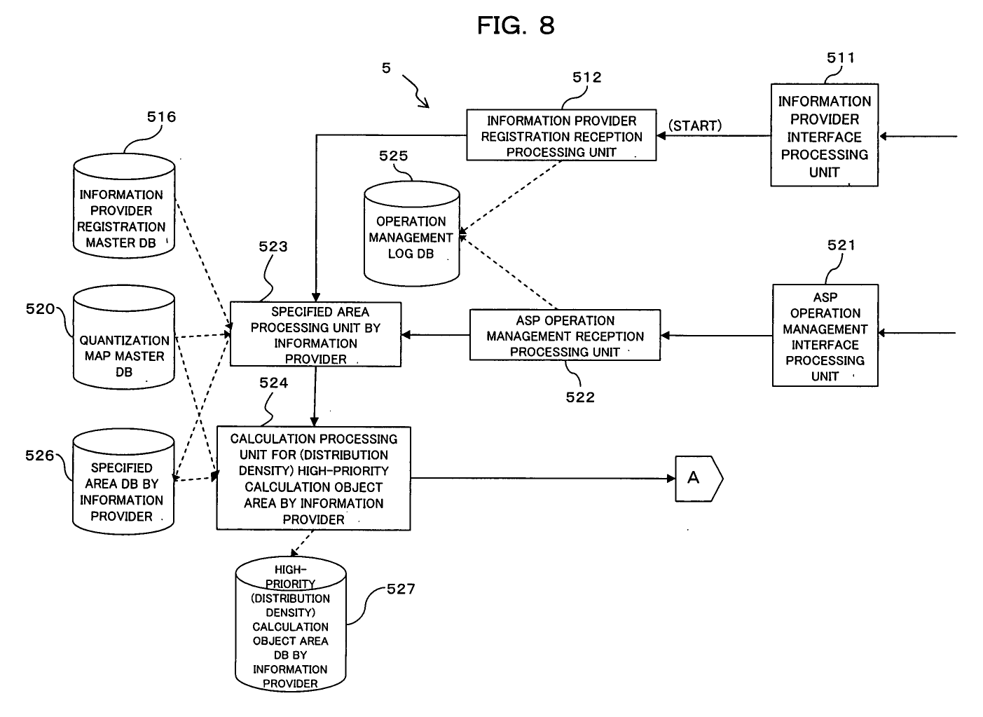

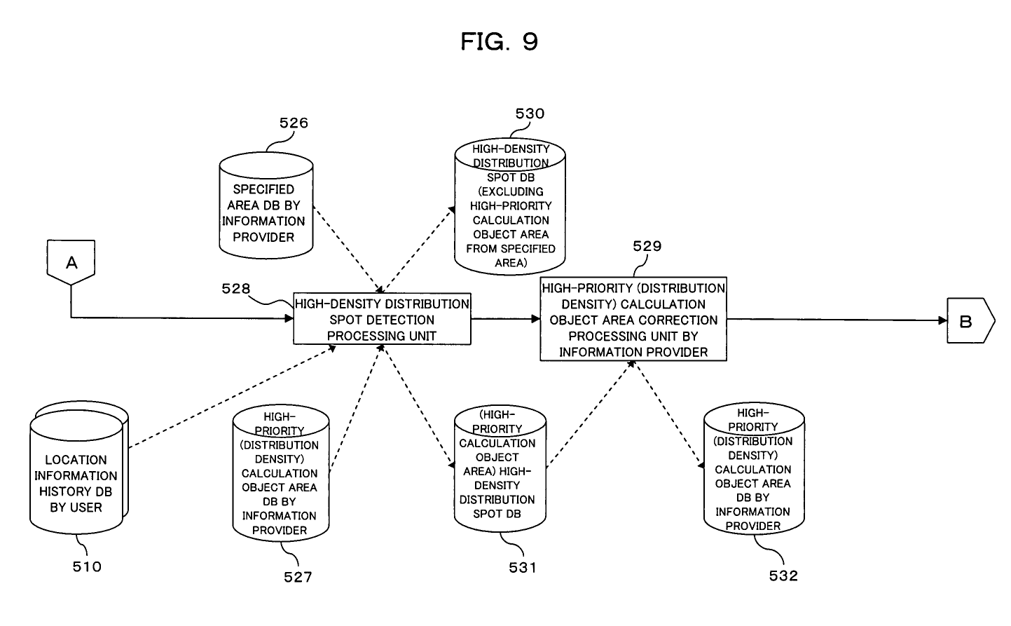

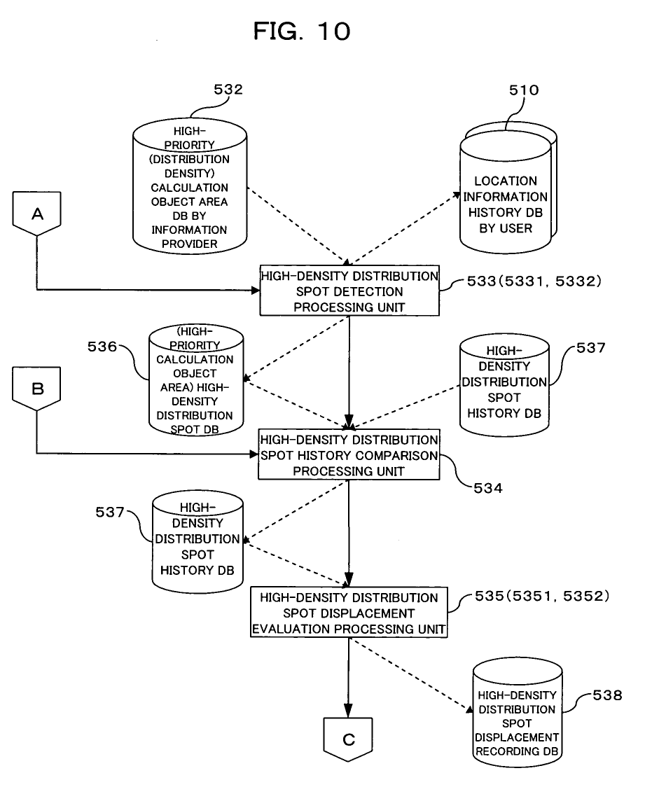

Next, FIG. 8 is a functional block diagram showing a construction of an ASP 5 of the present embodiment with attention paid to an ASP operation management/specified area processing function. As shown in FIG. 8, the ASP 5 includes the above-described elements as follows: the information provider interface processing unit 511; the information provider registration reception processing unit 512; the information provider registration master DB 516; and the quantization map master DB 520. In addition, as an ASP operation management/specified area processing function, the ASP 5 also includes: an ASP operation management interface processing unit 521; an ASP operation management reception processing unit 522; specified area processing unit by information provider 523; a calculation processing unit for distribution density high-priority calculation object area by information provider 524; an operation management log DB 525; a specified area DB by information provider 526; and a high-priority calculation object area DB by information provider 527. Here, in this FIG. 8, reference character A corresponds to reference character A in FIG. 9 and FIG. 10, and this indicates that the calculation processing unit for distribution density high-priority calculation object area by information provider 524 is connected to a high-density distribution spot detection processing unit 528 (described later with reference to FIG. 9) and a high-density distribution spot detection processing unit 533 (described later with reference to FIG. 10).

Here, the ASP operation management interface processing unit 521 interfaces between the ASP 5 and a terminal of an ASP operation/management administrator. The ASP operation management reception processing unit 522 evaluates instruction contents (information about a service area (specific area) specified by information provider 7, etc.) from the ASP operation/management administrator, and carries out processing corresponding to the evaluation result (recording a history in the operation management log DB 525, instructing the specified area processing unit by information provider 523 to calculate the terminal distribution density based on a specified area, and so on). In this instance, the operation management log DB 525 records a history of processing performed by the information provider registration reception processing unit 512 for the purpose of operation management of the whole of the ASP 5.

The specified area processing unit by information provider 523 carries out the following processing for each information provider 7 based on the recorded contents in the information provider registration master DB 516 and the quantization map master DB 520. The specified area processing unit by information provider 523 calculates, from the whole service area specified by the information provider 7, areas in which the distribution density calculation should be calculated with priority, with consideration paid to cities and towns in which a lot of object people to whom information should be distributed are assumed to live and the location of the information provider 7, and then records and stores the calculation result in the specified area DB by information provider 526. At that time, the above-mentioned area is stored in the specified area DB by information provider 526 as a data set in the form of which the area is converted into a unit block (or basic block) set and the area calculation can be performed.

The calculation processing unit for distribution density high-priority calculation object area by information provider 524 sets information distribution object areas for each information provider 7. Such information distribution object areas are smaller than the area specified as a service area, and distribution density calculation is carried out in such small areas with high priority. On the basis of the recorded contents in the quantization map master DB 520 and the specified area DB by information provider 526 (the processing result obtained by the specified area processing unit by information provider 523), the calculation processing unit for distribution density high-priority calculation object area by information provider 524 calculates, for each information provider 7, areas in which distribution density calculation should be performed with high priority, and then records and stores the calculation result in the high-priority calculation object area DB by information provider 527.

In this case, within the corresponding area X, the general formula for obtaining the distribution density DA(X) of the user property A in each unit block (x₁, x₂, . . . , xₙ) contained in the area X which has been set as a high-priority information distribution object area is expressed by the following formula (1):

$${D}_{A } ( x ) = \frac{\begin{matrix}{\sum }_{i = 1}^{n} the number of users with \\ user property A existing in unit block {x}_{i}\end{matrix}}{{\sum }_{i = 1}^{n} the area of unit block {x}_{i}} \qquad ( 1 )$$

In order to realize a function of recording information about the area specified by the information provider 7 and the ASP administrator, and a function of recording the specified area as a data set in a form by which the specified area can be calculated from map information, the ASP 5 has the following means:

(1) a means for (a) sending (i) information necessary for specifying an area which should be a service object area, which information is input from the terminal of the information provider 7 connected to the ASP 5 and the terminal of the ASP administrator or (ii) a list of options with a form in which the information provider 7 connected to the ASP 5 and the APS administrator can select, and for (b) receiving the response information thereto, and for (c) storing the response information [the registration menu output processing unit 514 (see FIG. 6), the information provider registration reception processing unit 512, and the specified area processing unit by information provider 523, and the specified area DB by information provider 526];

(2) a means for converting the corresponding area into a unit block (or basic block) set and storing the area in the form of a data set in which an area calculation is available (the specified area processing unit by information provider 523 and the specified area DB by information provider 526);

With this arrangement, on the ASP 5, when an “initiation” request of the present information distribution service is received from an information provider 7 via the information provider interface processing unit 511 and the request is then confirmed by the information provider registration reception processing unit 512, or when an instruction is received from an ASP operation administrator via the ASP operation management interface processing unit 521 and the instruction is confirmed by the ASP operation management reception processing unit 522, the information provider registration reception processing unit 512 and the ASP operation management reception processing unit 522 store the corresponding history in the operation management log DB 525.

On the other hand, in response to the above “initiation” request of the service or under instruction by the ASP operation administrator, on the ASP 5, the specified area processing unit by information provider 523 carries out the following processing based on the recorded contents in the information provider registration master DB 516 and the quantization map master DB 520. On the bases of the contents recorded in the information provider registration master DB 516 and the quantization map master DB 520, the specified area processing unit by information provider 523 calculates, from the whole service area specified by the information provider 7, areas in which the distribution density calculation should be carried out with priority, with consideration paid to cities and towns in which a lot of object people to whom information should be distributed are assumed to live and the location of the information provider 7, and then records and stores the calculation result in the specified area DB by information provider 526.

Further, on the ASP 5, the calculation processing unit for distribution density high-priority calculation object area by information provider 524 calculates areas in which distribution density calculation should be performed with priority, based on the recorded contents in the quantization map master DB 520 and the specified area DB by information provider 526, and then stores the calculation result in the high-priority calculation object area DB by information provider 527.

As described so far, in the area specified by the information provider 7 as a service area, areas in which calculation of the terminal distribution density should be carried out with high priority are selected and stored as a database. In this instance, it is of course possible to treat the whole area specified by the information provider 7 as a distribution density object area. However, in order to increase the processing efficiency, narrowing down the object area for distribution density calculation is advantageous from a point of view of effective use of computer resource and processing performance.

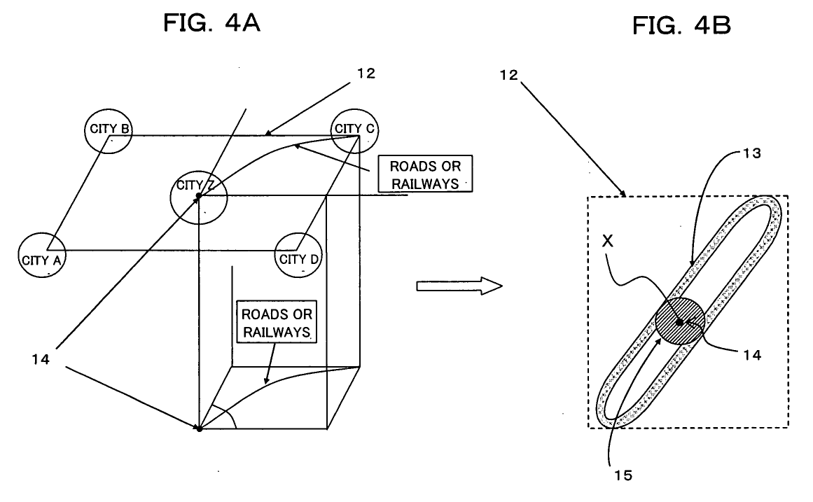

For example, as shown in FIG. 4A, when the information provider 7 specifies a rectangular area 12 with vertexes of City A, City B, City C, and City D (with the location of information provider 7 as a center point) as an area specified as an information distribution object area, it is significantly inefficient to calculate distribution density in all of the unit blocks in the rectangular area 12. This is because there are no users in most of the area.

In this instance, as described above, the present embodiment is based on the assumption that the ASP 5 can use information about places where people gather (seasonal factors are included) and transportation means. Thus, at initiation of the service, it is possible to exclude areas in which the terminal distribution density of the terminals 1 is low or to decrease calculation frequency.

That is, if map information applied in the present embodiment contains traffic access information (route information such as roads and railways along which people move), unit blocks covering such routes are determined as areas in which distribution density calculation is to be performed with priority, whereby areas in which distribution density calculation is to be performed with priority are considered to be elaborated. For example, as shown in FIG. 4B, when map information to be applied contains traffic access information such as roads and railways to City C, which is a landmark, a unit block set which covers the traffic access information is determined as an area 13 in which distribution density calculation is to be performed with high priority.

Further, if the area specified by the information provider 7 is a downtown area or a shopping street in which users walk around and thus the width of the area 15 is limited to some degree (for example, within 10 minutes' walk), the whole of the area 15 is determined as an area in which distribution density calculation is to be performed with high priority.

In contrast, if traffic access information is not contained in map information to be applied, the following method can be used to limit the area which serves as a distribution density calculation object area.

That is, for example, when customers of an information provider 7 mainly come from City C, it is meaningful to understand the movement of people from City C to the shop of the information provider 7. Here, setting a permissible range (a set of candidate areas for extracting areas in which distribution density calculation is to be performed with high priority) and calculating the distribution density with high priority in the permissible range and its adjacent areas will decrease the amount of calculation.

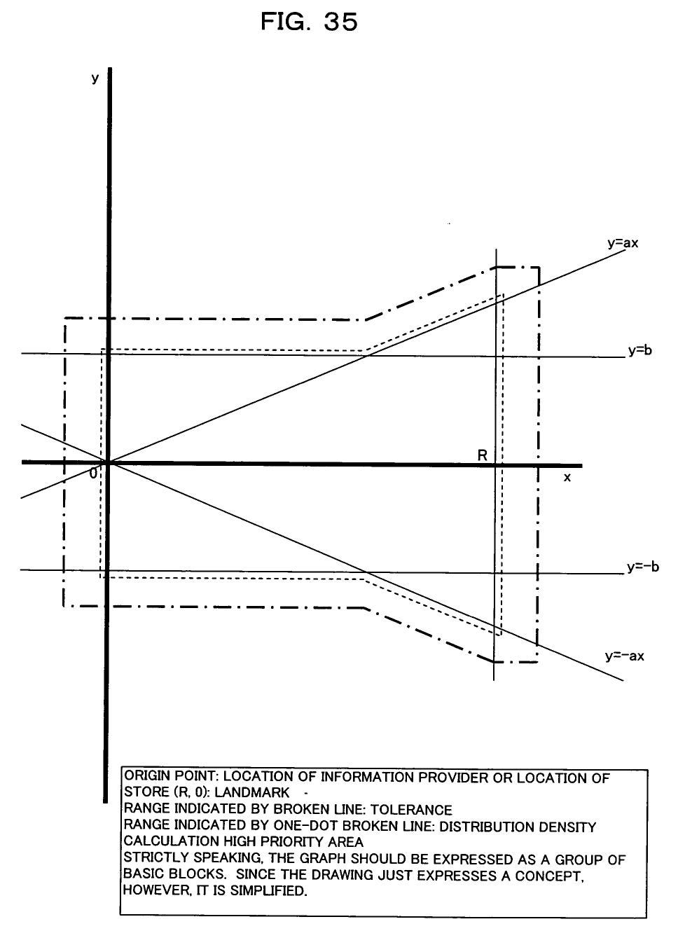

Therefore, taking the information provider 7 as the “origin”, a coordinate (for calculating a permissible range) transformation such that a straight line connecting the origin and City C is the x-axis and a straight line crossing the x-axis at right angles at the origin is the y-axis is carried out. On this coordinate system, the permissible range can be defined as a range(a) satisfying −b<y<b and 0<x<R, or a range (b) satisfying y=±ax and x<R (where R is a distance between the location of the information provider 7 or the provider's shop and a specified landmark), or a range (c) satisfying both (a) and (b) (see FIG. 35).

A basic block included in the permissible range or a basic block adjacent to the permissible range is extracted as a distribution density calculation priority area. By carrying out distribution density calculation only in this distribution density calculation priority area, it is possible to improve the efficiency of the distribution density calculation.

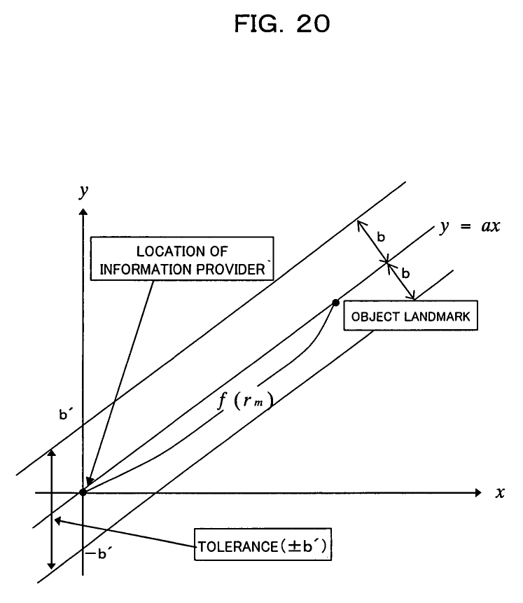

In this instance, this distribution density calculation priority area can be set, as shown in FIG. 20, in the following method: the straight line connecting the origin and City C is expressed by the linear function y=ax, and the range enclosed by the two straight lines defined by y=ax±b′ is treated as a permissive range. In this case, when b is expressed by a function where a basic block size is u and the distance between the location of the information provider 7 and the target landmark is rₘ, for example, the following is obtained:
b=f(n,u,rₘ)=f{(n×u)·f(rₘ)}(n≠0)
b′=b·(a²+1)^{1/2}

Further, a range enclosed by the two straight lines defined by y=a₁x and y=a₂x can be used as a permissive range.

(B5) Function of Making Accurate a Distribution Density Calculation Priority Area

FIG. 9 is a functional block diagram showing a construction of an ASP 5 of the present embodiment with attention paid to a function of making more accurate a distribution density calculation priority area. As shown in FIG. 9, the ASP 5 has the above-described elements as follows: the location information history DBs by person 510; the specified area DB by information provider 526; and the high-priority calculation object area DB by information provider 527. In addition, as a function of making accurate a distribution density calculation priority area, the ASP 5 also includes: a high-density distribution spot detection processing unit 528; a high-priority calculation object area correction processing unit by information provider 529; a high-density distribution spot DB (excluding high-priority calculation object area from specified area) 530; (high-priority calculation object area) high-density distribution spot DB 531; and high-priority calculation object area DB by information provider 532. In FIG. 9, reference character B corresponds to reference character B of FIG. 10, and it is indicated that the above high-priority calculation object area correction processing unit by information provider 529 is connected to a high-density distribution spot history comparison processing unit 534 (described later).

Here, the present “function of making accurate a distribution density calculation priority area” is a function of “narrowing down” areas in which distribution density calculation is to be performed with priority, based on the appearance state (frequency) of unit blocks or basic blocks which show the distribution density higher than a certain fixed “threshold” over elapsed time.

Further, the high-density distribution spot detection processing unit 528 detects the distribution state (appearance frequency) of high-density spots which appear in an area specified by the information provider 7, based on the contents stored in the location information history DB by user 510, the specified area DB by information provider 526, and the high-priority calculation object area DB by information provider 527. The location information history DB by user 510 stores location information of each user; the specified area DB by information provider 526 stores information about the area specified by the information provider 7 for each information provider; and the high-priority calculation object area DB by information provider 527 stores the high-priority calculation object information about the area contained in the specified area in which area the distribution density calculation is to be performed with high priority. The high-density distribution spot detection processing unit 528 then records and stores the above result in the high-density distribution spot DB (excluding high-priority calculation object area from specified area) 530 and the high-density distribution spot DB 531 in the calculation priority object area.

To realize the above, as a function for calculating the distribution density for each user characteristic specified for each unit block (or basic block), the high-density distribution spot detection processing unit 528 has a means for extracting users 1 with specified property from users present in an arbitrary area and counting the number of the extracted users, and also a means for calculating the distribution density of the above users in the above area from the counting result.

With such means, the ASP 5 is capable of detecting the distribution state of appearing high-density spots in the area specified by the information provider 7, based on city names, place names, addresses, the landmarks such as famous places and related buildings.

The high-priority calculation object area correction processing unit by information provider 529 corrects and updates the area in which the distribution density calculation is to be performed with high priority, based on the contents recorded in the high-density distribution spot DB 531 of the latest calculation priority object area. The result of the correction and updating are recorded and stored in the high-priority calculation object area DB by information provider 532, whereby the areas in which the distribution density calculation is to be performed with high priority are made accurate.

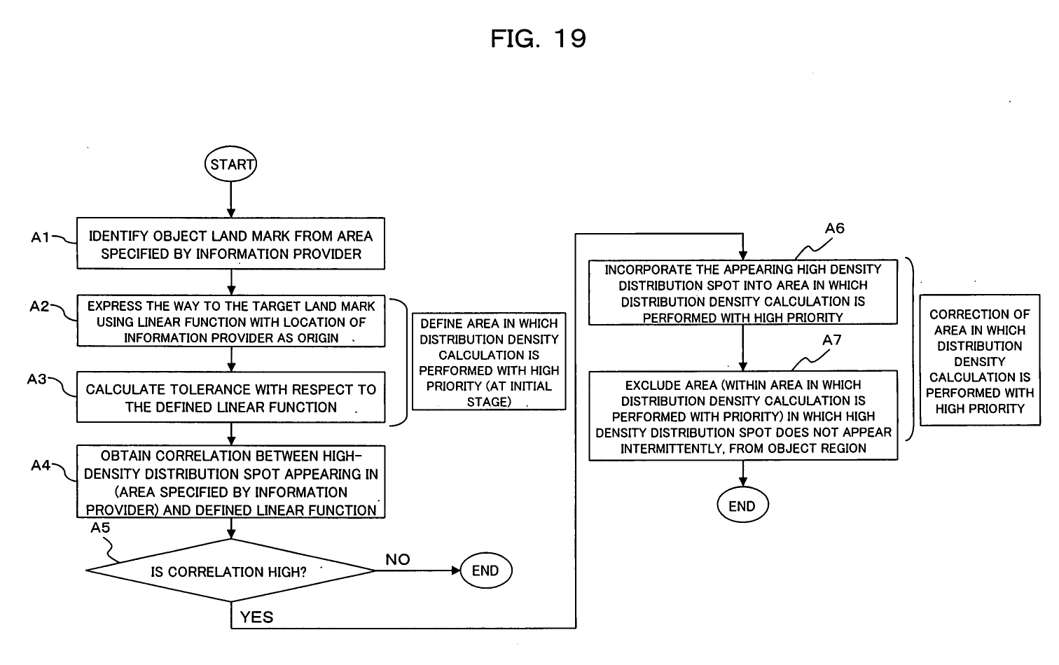

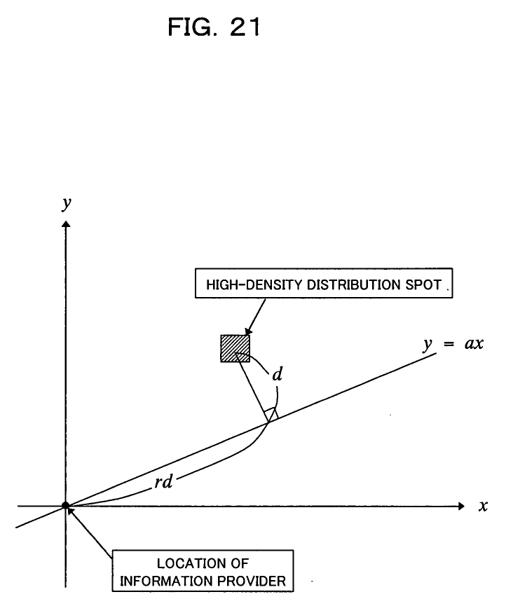

For example, as shown in FIG. 20 and FIG. 35, the information provider 7 is taken as the “origin”, and a straight line connecting to City C, which is a landmark, is expressed by a linear function y=ax (or x-axis), and a permissible range is expressed as y=ax±b′ (or y=±ax). In this case (corresponding to steps Al through A3 of FIG. 19), as shown in FIG. 21, by evaluating the distance d between a high-density spot appearing in that region and y=ax (or the x-axis), the effectiveness of the high-density spot can be evaluated. That is, if the high-density area appearing is far from the expected distribution density calculation priority area, it can be decided that the appearing high-density spot has a low effectiveness (correlation) (step A4 and NO route of step A5 in FIG. 19).

On the other hand, if the high-density spot appears in an area neighboring a distribution density calculation priority area which has been expected to appear immediately before (in cases where correlation is high: YES route of step A5), the high-density spot which appeared is added to the distribution density calculation priority area (permissible range)(step A6). In addition, in the distribution density calculation priority area which has been expected to appear immediately before, parts in which any high-density area has not appeared during a specified period or parts in which the appearance frequency is lower than a predetermined threshold are removed from the object area (permissible range).

Then, evaluation is performed once again in and around the new permissible area which has been determined so far, and the permissible range is updated. The above process is repeated until any increase or decrease in the new area is not present, then the updating of the permissible range is ended. In this manner, the process of making accurate the area in which distribution density calculation is to be performed with priority is carried out (step A7 in FIG. 19).

That is, according to the present embodiment, during a certain length of time, in the permissible range and its neighboring areas, the presence or absence of areas in which the frequency of occurrence of high-density spots is high is examined. Then, if a high-density spot which regularly appears is not included in the previously expected distribution density calculation high density area, and if the spot is not included in the neighboring area, either, it is decided that the expected distribution density calculation priority area is not correctly set. Parts of the distribution density calculation priory area in which no high-density spots appear is deleted therefrom, and areas in which high-density spots regularly appear are added thereto, thereby correcting the distribution density calculation priority area. As a result, the area in which distribution density calculation is to be carried out with priority is made accurate.

In this instance, the above function can be omitted if narrowing down (making accurate) of the area in which distribution density calculation is to be carried out with priority has already been performed. Further, the above processing for making accurate the area in which distribution density calculation is to be carried out with priority can be performed using either of unit blocks and basic blocks. The threshold value for use in deciding whether the frequency of appearance of the above high-density spots is high or low should be initially set to a relatively low value, and with data accumulation over time, the threshold value should be set to higher values. As a result, the permissible range is narrowed down, thereby making efficient the operation of the ASP 5.

(B6) Function of Evaluating High-density Distribution Spot Appearance State (Movement Displacement):

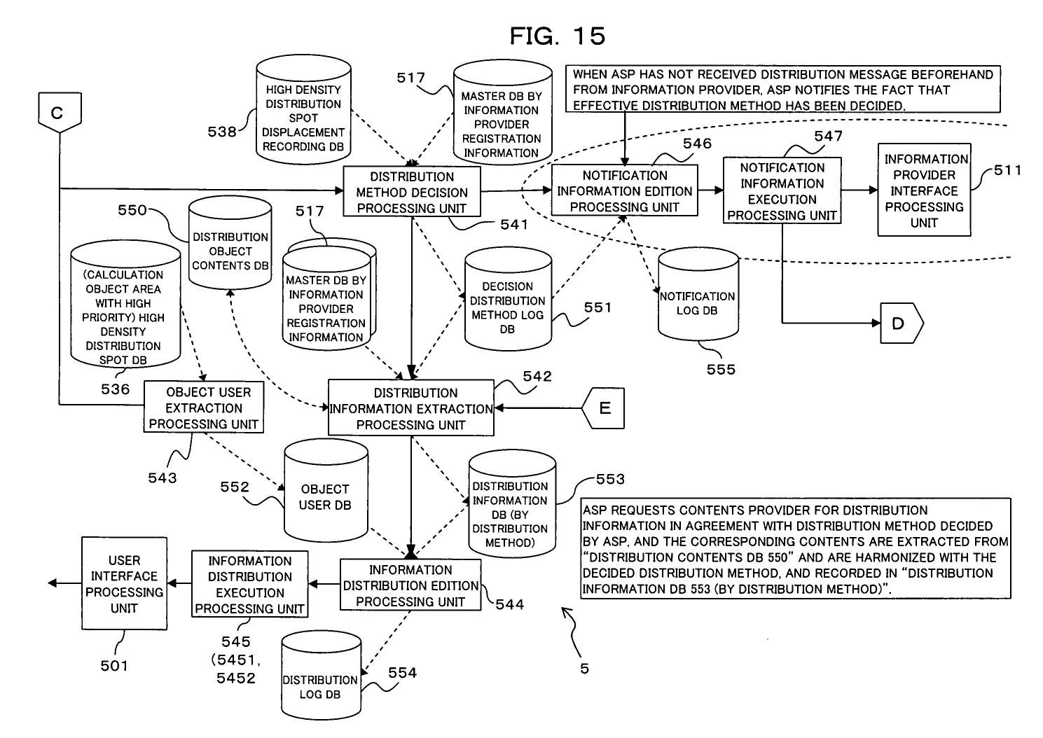

Next, FIG. 10 is a functional block diagram showing a construction of an ASP 5 of the present embodiment with attention paid to a high-density distribution spot appearance state (movement displacement) evaluating function. As shown in FIG. 10, the ASP 5 has the above-described location information history DBs by user 510 and high-priority calculation object area DB by information provider 532. In addition, as a high-density distribution spot appearance state (movement displacement) evaluation function, the ASP 5 includes: a high-density distribution spot detection processing unit 533; high-density distribution spot history comparison processing unit 534; a high-density distribution spot displacement evaluation processing unit 535; high-priority calculation object area high-density distribution spot DB 536; high-density distribution spot history DB 537; and high-density distribution spot displacement recording DB 538. In this instance, in FIG. 10, reference character C corresponds to reference character C in FIG. 15, and this indicates that the above-mentioned high-density distribution spot displacement evaluation processing unit 535 is connected to the distribution method decision processing unit 541 and the object user extraction processing unit 543, which will be detailed later with reference to FIG. 15.

Here, the present “high-density distribution spot appearance state (movement displacement) evaluation function” is a function for estimating the movement displacement tendency of a high-density distribution spot appearing in an area in which distribution density calculation is performed with high priority and a function for estimating an area in which the next high-density distribution spot is expected to appear, based on the estimated tendency.

The high-density distribution spot detection processing unit 533 detects high-density distribution spots which appear with a distribution density exceeding a specified “threshold value”, based on the contents recorded in the location information history DBs by user 510, each of which stores the location information history of each user, and on the contents recorded in the high-priority calculation object area DB by information provider 532, and then records and stores the detection result in the high-density distribution spot DB 536 of the calculation priority object area.

That is, the high-density distribution spot detection processing unit 533 performs a function of a distribution state change monitoring means which monitors change in the distribution state of the terminals 1 of service users with a specific user property in the information distribution object area over time, based on the location information of the terminals 1. To perform this function, the high-density distribution spot detection processing unit 533 also has the following functions:

(a) a function of a distribution density calculation unit 5331 which calculates the distribution density of mobile information terminals of service users with a specific user property in a specified area contained in the information distribution object area, based on the location information of terminals 1; and

(b) a function of a high-density distribution area detecting unit 5332 which detects a high-density distribution area, in which the distribution density is higher than a specified threshold value, based on the calculation results obtained by the distribution density calculation unit 5331;

Further, the high-density distribution spot history comparison processing unit 534 (i) compares the contents recorded in the high-density distribution spot DB 536 of a calculation priority object area, which DB 536 stores the latest high-density distribution spot information, with the contents recorded in the high-density distribution spot history DB 537, which stores high-density distribution spot information in the past, and (ii) records and stores the latest high-density distribution spot information in the high-density distribution spot history DB 537.

The high-density distribution spot displacement evaluation processing unit 535 (i) evaluates the movement displacement of the high-density distribution spot based on characteristics of the appearance state of high-density distribution spots, which characteristics are recognized from the latest high-density distribution spot in the high-density distribution spot history DB 537, and (ii) records and stores the movement displacement information in the high-density distribution spot displacement recording DB 538. Here, the high-density distribution spot displacement evaluation processing unit 535 functions as a high-density distribution spot movement displacement calculation unit 5351 which calculates the movement displacement of the high-density distribution spot detected by the high-density distribution spot detection processing unit 533, and also functions as a high-density distribution spot movement prediction unit 5352 which predicts the destination of the high-density distribution spot based on the movement displacement obtained by the high-density distribution spot movement displacement calculation unit 5351.

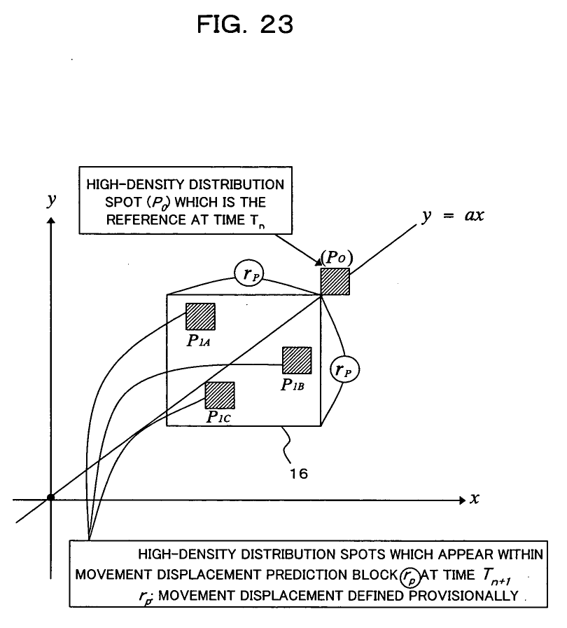

Here, as a concrete prediction method, for example, in order to evaluate whether a high-density distribution spot is present within “a certain permissible range”, the “movement displacement prediction area” is defined. In the distribution density calculation priority object area, this “movement displacement prediction area” has a high-density distribution spot P₀ appearing at time T₀ as a reference (origin) point. The “movement displacement prediction area” is a unit block group or a basic block group which covers a rectangular area (see e.g., FIG. 23) one of whose vertexes is one of the vertexes of the spot P₀ that appears at time T₀, or a circular area with a radius rₚ whose center is the high-density distribution spot that appears at time T₀. In this instance, a high-density distribution spot P₁ appearing at the next time T₁ has a side expressed by a function [r=f{Td×(U×n)} where n is an integer not smaller than 1] of a time interval (Td) at which distribution density calculation is performed and a basic block size (U) of the distribution density calculation.

At time T₁, terminal set S₁ present at high-density distribution spot P₁ which appears within the “movement displacement prediction area” and terminal set S₀ present at high-density distribution spot P₀ which appears at time T₀, which is a reference time, can have a relationship expressed by the following formula (2):
S₁⁻S₀ (2)

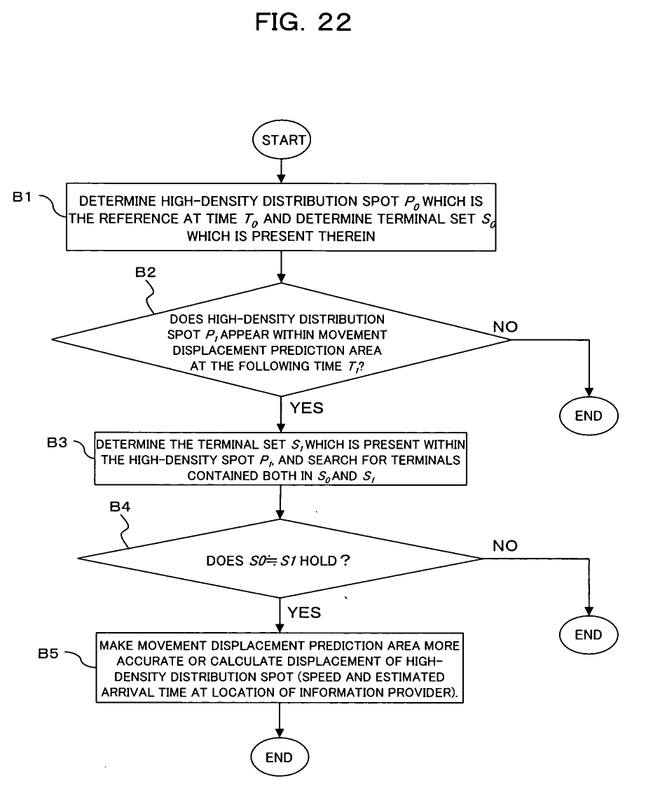

That is, (a) when terminals which were contained in the terminal set S₀ that is present within the high-density distribution spot P₀ at time T₀ are contained in the terminal set S₁ that is present within the high-density distribution spot P₁ at time T₁ at a rate higher than a specified rate (threshold value), it can be considered that the high-density distribution spot P₀ at time T₀ has moved to the high-density distribution spot P₁ by time T₁ (step B1 of FIG. 22, from YES route of step B2 to step B3, YES route of step B4). At this time, the distance between P₀ and P₁ is defined as a movement displacement of the high-density distribution spot.

Here, as described above, if a transportation access means (traffic information such as railways or roads) within the calculation priority object area is confirmed based on map information, etc., using a normal movement speed (v) which is assumed based on the traffic access means [for example, if the transportation means are automobiles on general roads, the normal speed is assumed to be 40 km (in Japan); if the transportation means are automobiles on highways, the speed is assumed to be 80 km (in Japan)], a “movement displacement predicted area” is defined by (v×Td)/U.

In contrast, (b) when a transportation access means cannot be confirmed from map information, it is possible, for example, to assume that the transportation access means is an automobile. In this instance, it is possible to make accurate (narrow down) the assumed “movement displacement predicted area”. That is, in this case, as the movement displacement predicted area size cannot be determined initially, it is necessary to examine the relationship of an inclusion rate of terminals 1 with respect to all the high-density distribution spots in the vicinity of P₀ for the purpose of determining P₁ using the above method (a). Once determined, the movement displacement predicted area size can be made accurate according to the appearance of high-density distribution spots.

For example, when the high-density distribution spot which is a reference at time T₀ is given as P₀, and its coordinate is given as (X₀,Y₀). In addition, the high-density distribution spot whose movement displacement is seen at time T₁ is given as P₁ₓ (x means A,B, . . . ), and its coordinate is given as (X₁,Y₁)(corresponding to step B1 of FIG. 22). Then, the movement displacement prediction area size can be calculated by the following formula (3):
\sqrt{(X₀-X₁)²+(Y₀-Y₁)²} (3)

The movement displacement (velocity v) is calculated by the following formula (4):

$$v = \frac{\sqrt{{( {X}_{0} - {X}_{1} )}^{2} + {( {Y}_{0} - {Y}_{1} )}^{2}}}{{T}_{d}} \qquad ( 4 )$$

(T_{d}=T₁−T₀: distribution density calculation interval)

Accordingly, the general formula for obtaining the movement displacement prediction area size in this case is given as (v×Td)/U. In this instance, it is possible to set the “movement displacement prediction area” using the above-mentioned method in which the “movement displacement prediction area” has a rectangular shape with a vertex that is a reference high-density distribution spot or a circular shape with a center that is a reference high-density distribution spot.

At time T₁, the relationship (correlation) between the terminal set S₁, which is a group of terminals present in the high-density distribution spot P₁ that appears within a movement displacement prediction area, and the terminal set S₀, which is a group of terminals present in the high-density distribution spot P₀ at time T₀, can be evaluated as follows (see from YES route of step B2 to step B3 and B4 in FIG. 22). If the terminal set contained in each high-density distribution spot P₁ₓ (x is A, B, or C) which appears within a movement displacement prediction area at the next time T₁ is given as S₁ₓ (see FIG. 23), it is possible to evaluate the correlation depending upon whether or not a common set between each S₁ₓ and S₀ is greater than a predetermined rate (for example, 90%).

That is, if the terminal set S₁ₓ constituting the high-density distribution spot which appears at time T₁ contains the terminals 1 which were contained in the terminal set S₀ which constituted the high-density distribution spot P₀, which was a reference at time T₀, at a specific rate or higher, it is judged that the high-density distribution spot P₀ at time T₀ constitutes (moves to) the high-density distribution spot of S₁ₓ (see YES route of step B4 in FIG. 22).

After that, the above-described elaboration of the movement displacement prediction area and calculation of the displacement (the speed, the distance to the location of the information provider 7, estimated arrival time) of the high-density distribution spot (will be detailed later) are performed (see step B5 in FIG. 22).

In this instance, at time T₁, if no high-density distribution spot appears within the “movement displacement prediction area”, or if S₁ₓ⁻S₀ is not held, revealing low correlation between S₁ₓ and S₀, the ASP 5 ends the processing (see NO route of step B2 or step B4 in FIG. 22).

That is, the above-mentioned high-density distribution spot history comparison processing unit 534 and high-density distribution spot displacement evaluation processing unit 535 function as a distribution state predicting means which predicts a distribution state of the users (terminals 1) with a specific property in the future, based on the monitoring result of time-series changes in the terminal distribution state obtained by the high-density distribution spot detection processing unit 533 which functions as a distribution state change monitoring means.

By means of the functions of the high-density distribution spot detection processing unit 533, the high-density distribution spot history comparison processing unit 534, and the high-density distribution spot displacement evaluation processing unit 535, the ASP 5 records the movement displacement of the high-density distribution spot appearing within an area in which distribution density calculation is to be performed with priority in the high-density distribution spot displacement recording DB 538, thereby creating a database.

In this instance, the high-density distribution spot displacement evaluation processing unit 535 is capable of obtaining “a total number of appearances”, “the mean number of appearances”, “the tendency (appearance tendency) of mean distribution density”, “the tendency of change in the mean distribution density”, “the tendency of change in standard deviation (dispersion)”, of the high-density distribution spot within the calculation priority object area during a specified time period as well as the appearance state (movement displacement) of a high-density distribution spot with a specific property within the same area at a certain time. As will be described later, these information elements are used in selecting a method in which distribution efficiency is high, when information distribution is actually performed.

Here, when calculating the dispersion of a specific user property distribution density within the above-mentioned area based on the distribution density by user property, the general formula of the dispersion SA(X) of user property A in the corresponding area X, is expressed by the following formula (5):
S_{A}(x)=\sqrt{S_{A}(x)²} (5)
and in this formula (5), S_{A}(x)² is expressed by the following formula (6):

$${{S}_{A} ( X )}^{2} = \frac{{\sum }_{i = 1}^{m} ( {D}_{A} ( {X}_{i } ) - \overline{{{D}_{A} ( X ) )}^{2}}}{m - 1} \qquad ( 6 )$$

where m designates the number of unit blocks which cover the area (X); D̅_̅{̅A̅}̅(̅X̅)̅ designates the mean distribution density of user property A in the area X.

(B7) Distribution Density Time-series Change Recording and Predicting Function:

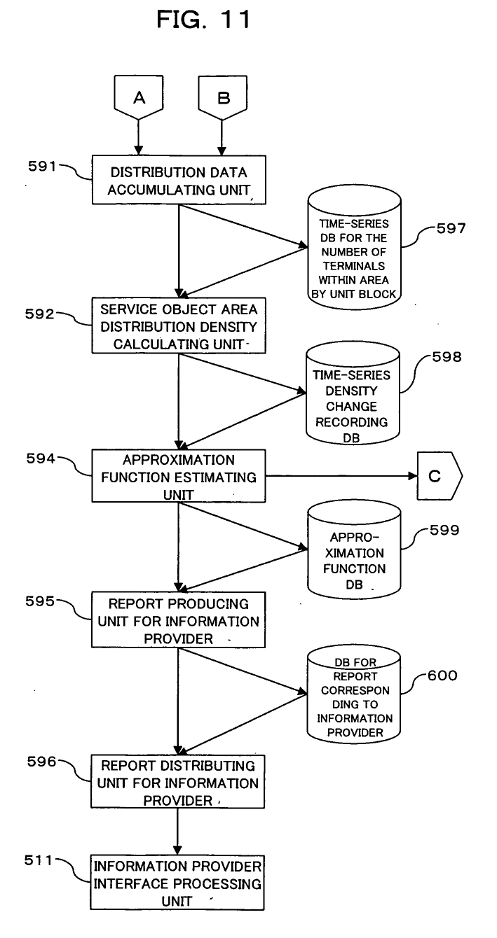

FIG. 11 is a functional block diagram showing a construction of the ASP 5 of the present embodiment with attention paid to a distribution density time-series change recording and predicting function. As shown in FIG. 11, the ASP 5 has the above-described functions. In addition, as a distribution density time-series change recording and predicting function, the ASP 5 includes: a distribution data accumulating unit 591; a service object area distribution density calculating unit 592; a an approximation function estimating unit 594; a report producing unit for information provider 595; a report distributing unit for information provider 596; a time-series DB for the number of terminals within area by unit block 597; a time-series density change recording DB 598; an approximation function DB 599; and a DB for report corresponding to information provider 600. In FIG. 11, reference character A corresponds to reference character A of FIG. 8; reference character B corresponds to reference character B of FIG. 9; reference character C corresponds to reference character C of FIG. 15.

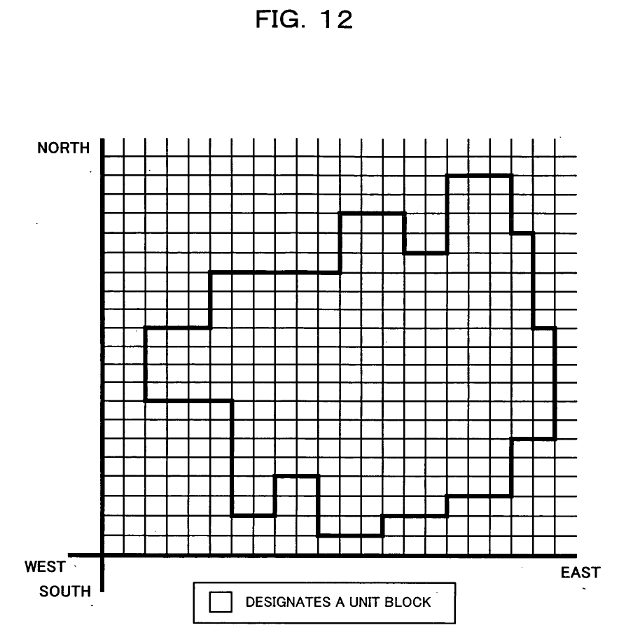

Here, the distribution data accumulating unit 591 sets an appropriate time interval (for example, every 10 minutes), and it records, in time series, data about the number of terminals 1 with a specific user property which are present in each unit block (or basic block) in an area which is specified by the information provider 7 or which is set by the ASP administrator as a service object area. FIG. 12 shows a relationship between a service object area and unit blocks. The data about the number of terminals 1 present in each unit block can be obtained in the process described with reference to FIG. 10, in which process data for the high-density distribution spot displacement recording DB 538 is obtained. That is, the data about the number of terminals 1 can be obtained based on the contents recorded in the location information history DBs by user 510 of FIG. 10, which stores the location information history of each user, and in the high-priority calculation object area DB by information provider 532.

The service object area distribution density calculating unit 592 obtains time-series (over time) change in distribution density (or dispersion) by user property, based on data in the time-series DB for the number of terminals within area by unit block 597. The service object area distribution density calculating unit 592 calculates necessary data such as distribution density [or dispersion (the state of dispersion)] of terminals 1 with a specific user property in each unit block (or basic block) in the above service object area, and then stores the calculation result in the time-series density change recording DB 598.

That is, the service object area distribution density calculating unit 592 records, in the time-series density change recording DB 598, change in time series (by the unit of day, day of the week, week, month, and year) in distribution density (the state of concentration) and dispersion (the state of dispersion) by arbitrary user property in an arbitrary area specified by the information provider 7 and the ASP administrator, whereby the service object area distribution density calculating unit 592 functions as a means for monitoring the state of movement of high-density distribution spots.

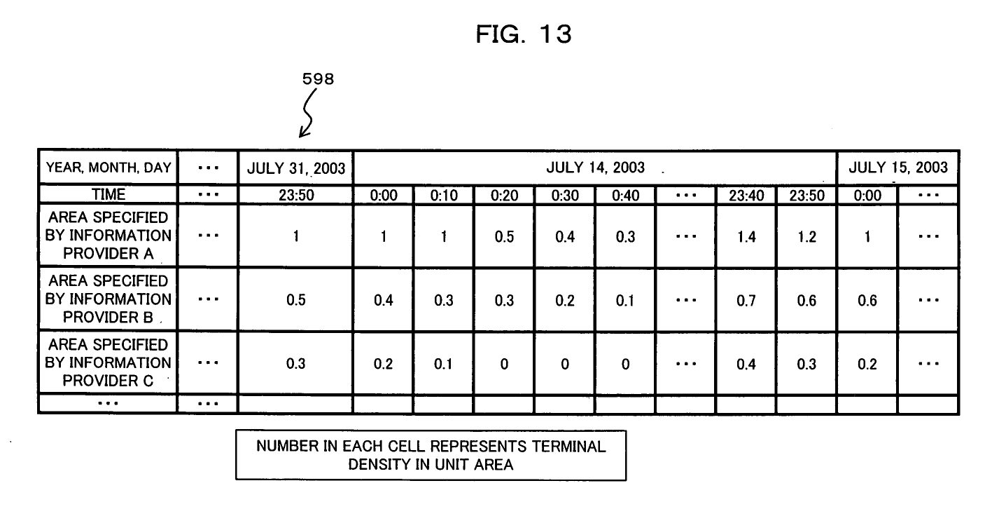

The time-series density change recording DB 598 stores information about object areas which are specified by the information provider 7 or about object areas which are set by the administrator of the ASP 5. FIG. 13 shows an example of contents recorded in the time-series density change recording DB 598. As shown in FIG. 13, the time-series density change recording DB 598 stores distribution density of terminals 1 with a specific user property present in a unit block in the service object areas by information providers A, B, C, . . . , at a time interval of 10 minutes.

In this instance, to simplify the table, in FIG. 13, the times and the time intervals at which the location information of each terminal is obtained are uniform. However, in actual cases, the times and the time intervals are normally varied. With such data, it is still possible to apply the following approximation method.

That is, as in the case of the high-density distribution spot detection processing unit 533, the distribution data accumulating unit 591 and the service object area distribution density calculating unit 592 function as a distribution state change monitoring means, which monitors change over time in the distribution state of service users (terminals 1) with a specific user property in an information distribution object area based on location information of the terminals 1.

The approximation function estimating unit 594, as in the case of high-density distribution spot history comparison processing unit 534 and the high-density distribution spot displacement evaluation processing unit 535, functions as a distribution state predicting means, which predicts a future-distribution state of users (terminals 1) with a specific user property based on the result of the above-mentioned terminal distribution state. Here, on the basis of the contents recorded in the time-series density change recording DB 598, the approximation function estimating unit 594 estimates an approximation function of the cycle (daily cycle, weekly cycle, monthly cycle, yearly cycle, or the like) of the time-series change of distribution density in unit blocks (or basic blocks) contained in the service object area of each information provider 7.

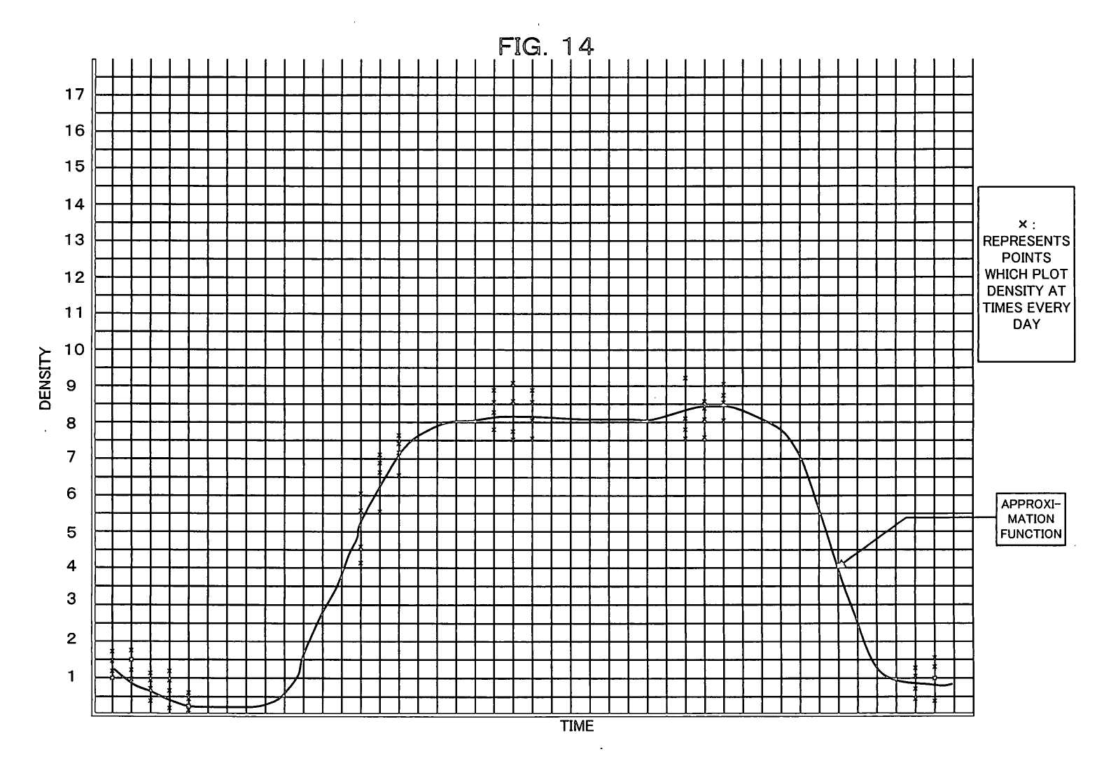

For example, if the density is given as d, and the time is given as t, an approximation function of d=f(t) is estimated. A concrete example is as follows. For example, when estimating the approximation function of time-series change in weekdays, data of Monday to Friday of every week (if public holidays exist, they are excluded) is extracted. Then, as shown in FIG. 14, the data is plotted in a graph whose vertical axis represents density and whose horizontal axis represents time, thereby evaluating the general tendency. If there exists a single peak, the graph is assumed to be a curve of second degree, and if there exist two peaks, the graph is assumed to be a curve of fourth degree. When the graph is a curve of second degree, d is given as:
d=at²+bt+c (a, b, and c are coefficients)
When the graph is a curve of fourth degree, d is given as:
d=at⁴+bt³+ct²+dt+e (a, b, c, d, and e are coefficients)
The coefficients are estimated by using the least squares method or the like. The thus-obtained approximation function formula is recorded in the approximation function DB 599 separately for each information provider 7. Further, the function used in approximation is not limited to a higher degree function, and an appropriate linear function can also be used. Alternatively, a constant for each block can be used.

The report producing unit for information provider 595 produces a report to be provided to the information provider 7, which report includes information about areas predicted to be high-density distribution areas as prediction data that will be useful in future information distribution. The report distributing unit for information provider 596 distributes (sends) the report, which is produced by the report producing unit for information provider 595, to the information provider 7 via the information provider interface processing unit 511 (see FIG. 8).

That is, the report producing unit for information provider 595 and the report distributing unit for information provider 596 function as a movement prediction data providing means which provides the information provider 7 with information corresponding to the estimation result obtained by the approximation function estimating unit 594 as movement prediction data of service users.

In this instance, these functions of the report producing unit for information provider 595 and the report distributing unit for information provider 596 can be realized as one of the functions of the notification information edition processing unit 546 and the notification information execution processing unit 547.

With such “distribution density time-series change recording and predicting functions”, the ASP 5 is capable of recording time-series change in terminal distribution density by user property in the past service object areas, and is capable of predicting change in the future distribution density based on the recorded contents (that is, a history of time-series change in the past distribution density), and is capable of providing the information provider 7 with the prediction result (prediction information of movement of service users). Thus, it is possible to provide the information provider 7 with an opportunity to appropriately specify the areas in which information distribution efficiency (advertisement efficiency) is likely to be high in the future and the distribution method.

In this instance, the above-mentioned prediction result (approximation function) can be used as information based on which a distribution method high in information distribution efficiency is determined in the following “information distribution processing function”.

(B8) Information Distribution Processing Function:

FIG. 15 is a functional block diagram showing a construction of the ASP 5 of the present embodiment with attention paid to an information distribution processing function of the ASP 5. As shown in FIG. 15, the ASP 5 has the above-described user interface processing unit 501, the information provider interface processing unit 511, the master DB by information provider registration information 517, and the high-density distribution spot DB 536. In addition, as an information distribution processing function, the ASP 5 includes: a distribution method decision processing unit 541; a distribution information extraction processing unit 542; an object user extraction processing unit 543; an information distribution edition processing unit 544; an information distribution execution processing unit 545; a notification information edition processing unit 546; a notification information execution processing unit 547; a distribution object contents DB 550; a decision distribution method log DB 551; an object user DB 552; a distribution information DB by distribution method 553; a distribution log DB 554; and a notification log DB 555.

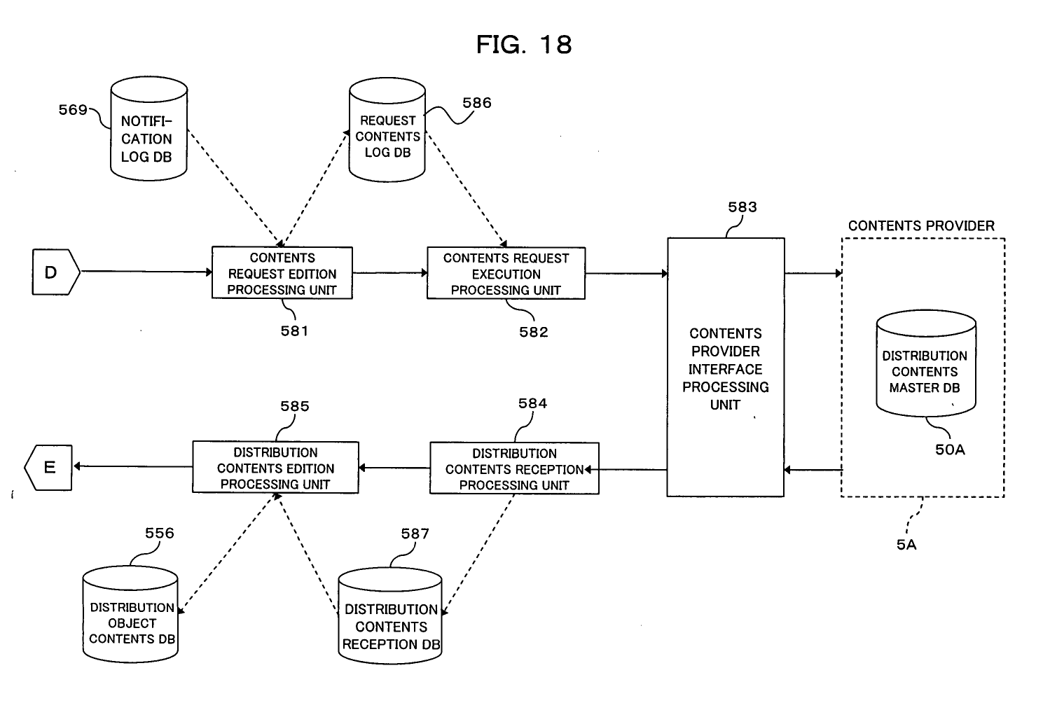

In FIG. 15, reference character D and reference character E correspond to reference character D and reference character E, respectively, in FIG. 18. This indicates that the notification information execution processing unit 547 is connected to a contents request edition processing unit 581 (will be detailed later with reference to FIG. 18), and that the distribution information extraction processing unit 542 is connected to a distribution contents edition processing unit 585 (will be detailed later with reference to FIG. 18).

Here, in order to provide the information provider 7 with high distribution efficiency and high cost performance in information distribution, the “information distribution processing function” is a function of carrying out information distribution to the above-defined distribution density calculation priority areas (=areas in which high-density distribution spots frequently appear). In this example, on the basis of the terminal distribution state prediction result obtained by the above-described (with reference to FIG. 10) distribution state predicting means (high-density distribution spot history comparison processing unit 534 and high-density distribution spot displacement evaluation processing unit 535), the “information distribution processing function” functions as an information distribution means which carries out information distribution to service users (terminals 1).

The distribution method decision processing unit 541 determines a distribution method whose distribution efficiency is high, based on the contents recorded in the high-density distribution spot displacement recording DB 538, which stores the characteristics of appearance of high-density distribution spots, and in the master DB by information provider registration information 517, which stores distribution information and distribution condition specified by the information provider 7. The distribution method decision processing unit 541 then records and stores the determination result in the distribution method log DB 551. In the present embodiment, the distribution method decision processing unit 541 also has a function of a distance/arrival time estimating unit 5411 which estimates (calculates) the distance from a high-density spot to the location of the information provider 7 (or the place specified by the information provider 7) and/or arrival time, based on the above-described movement displacement of the above high-density distribution spot.

The distribution information extraction processing unit 542 extracts information to be distributed, based on the contents recorded in the master DB by information provider registration information 517, which stores distribution information registered by the information provider 7 beforehand, the distribution object contents DB 550, which stores distribution information provided by a contents provider 5A (see FIG. 18), and the distribution method log DB 551, which stores the distribution method determined by the distribution method decision processing unit 541. The distribution information extraction processing unit 542 then records and stores the extracted information in the distribution information DB by distribution method 553.

At that time, the distribution information extraction processing unit 542 requests the contents provider 5A for distribution information which is in agreement with the distribution method determined by the ASP 5 (distribution method decision processing unit 541), and extracts the corresponding distribution contents from the distribution object contents DB 550. The distribution information extraction processing unit 542 then obtains matching between the extracted distribution contents and the determined distribution method, and stores the distribution contents in the distribution information DB by distribution method 553.

The object user extraction processing unit 543 extracts terminals 1 to which information distribution is to be performed from the calculation priority object area with high priority high-density distribution spot DB 536, which DB stores information about terminals 1 (users) constituting high-density distribution spots. The result is stored in the object user DB 552. That is, this object user extraction processing unit 543 extracts users who are in agreement with the user property (information fields asked by users and information fields users are interested in) specified by the information provider 7 or the ASP administrator, from service users who are present in the service object area, and then records the users in the object user DB 552.

The information distribution edition processing unit 544 edits information to be distributed to terminals 1 based on the distribution information corresponding to the distribution method determined by the distribution method decision processing unit 541. In addition, the information distribution edition processing unit 544 associates the distribution information with the terminal 1 to which the information is to be distributed, and stores the association result in the distribution log DB 554.

The information distribution execution processing unit 545 sends the distribution information edited by the information distribution edition processing unit 544 to each terminal 1 via the user interface processing unit 501. That is, the information distribution execution processing unit 545 performs the following two functions: a function as an information distribution unit 5451 of a high-density distribution spot prediction type, which selectively distributes the information corresponding to the destination spot which is predicted by the high-density distribution spot displacement evaluation processing unit 535 (see FIG. 10); and a function as an information distribution unit 5452 of a distance/arrival time estimating type, which distributes the information corresponding to the distance and/or arrival time estimated by the above-mentioned distance/arrival time estimating unit to users (terminals 1) in the high-density distribution spot.

When the information provider 7 is not given any distribution information (registration is not performed) beforehand (at the time of enrollment), the notification information edition processing unit 546 edits and creates the contents to be notified (recommended) to the information provider 7, based on the contents recorded in the decision distribution method log DB 551, which stores the determined distribution method, in order that the ASP asks the information provider 7 for provision of distribution information, including advice such as determination of the effective distribution method and information construction contents suitable for the determined distribution method. The notification information edition processing unit 546 then records the result in the notification log DB 555. The notification information execution processing unit 547 sends to the information provider 7 via the information provider interface processing unit 511 a notification that the distribution method has been determined.

That is, the notification information edition processing unit 546 and the notification information execution processing unit 547 carry out a function as a high-density distribution spot movement prediction result notifying unit which notifies the information provider 7 of the high-density distribution spot prediction result, and a function as a distribution information recommending unit which recommends to the information provider 7 the distribution information contents corresponding to the distance/arrival time estimated in the above-described manner.

In a large-sized downtown area (for example, in the vicinity of Ginza, Yuraku-cho, Shinjuku, and Shibuya), the density is high as a whole, but it hardly occurs that a flow of people moves from a certain place to another place. Thus, from a point of view of unit blocks, the mean value of density is high, but movement is at random. In such a case, it is impossible to apply the method in which information is distributed based on the movement tendency, and it is appropriate to examine the tendency of the whole.

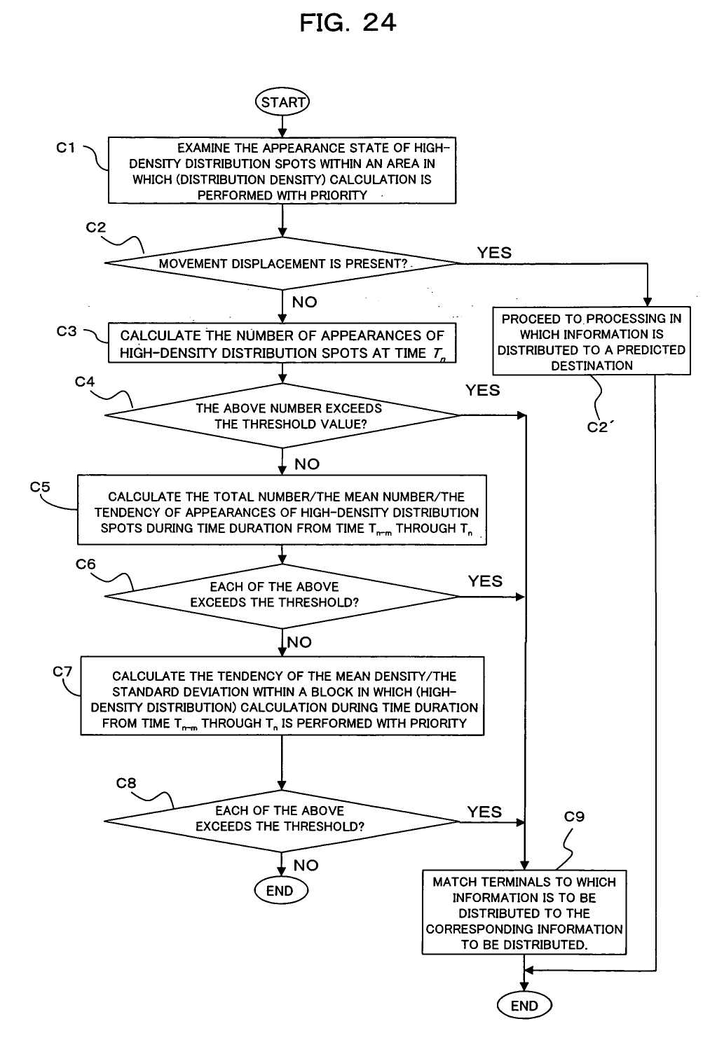

In order to support such a case, FIG. 24 shows the procedures for evaluating whether or not the object area is a high-density area as a whole (whether the area is suitable for information distribution). That is, first of all, on the ASP 5, the high-density distribution spot displacement evaluation processing unit 535 examines the state of appearance of high-density distribution spots in areas in which distribution density calculation is to be performed with high priority (step C1), and evaluates the presence or absence of high-density distribution spots which definitely move (step C2). As a result, if any high-density distribution spot that moves exists, its destination is predicted, and information distribution processing is performed (from YES route of step C2 to step C2′). If no such moving high-density distribution spot exists, the number of appearances of high-density distribution spots appearing at time tn is calculated (from NO route of step C2 to step C3), and it is evaluated whether or not the number exceeds a specific threshold value (step C4).

If the number of appearances of high-density distribution spots does not exceed the threshold value (NO route of step C4), the ASP 5 (high-density distribution spot displacement evaluation processing unit 535) calculates a total number of appearances of high-density distribution spots, a mean number of appearances of high-density distribution spots, and the tendency of appearances of the high-density distribution spots during a time period from time Tₙ₋ₘ to Tₙ (step C5), and evaluates whether each of the above values exceeds its specific threshold values (step C6).

As a result, if none of the values exceeds its threshold value, the ASP 5 calculates the tendency of the mean density and the standard deviation in areas in which distribution density calculation is to be performed with priority during the time period from time Tₙ₋ₘ to Tₙ (from NO route of step C6 to step C7), and evaluates whether or not each of the values exceeds a specific threshold value (step C8). If both of the values do not exceed the threshold value, the ASP 5 ends the processing (NO route of step C8).

In contrast, in the above step C4, C6, or C8, if the object value exceeds the threshold value (YES route of step C4, step C6 or step C8), the ASP 5 performs matching of the terminal 1 which is an information distribution object with the corresponding distribution information (step C9).

That is, if the information provider 7 has registered distribution information beforehand (at enrollment), the distribution method decision processing unit 541 determines an efficient distribution method based on the contents recorded in the high-density distribution spot displacement recording DB 538 and the master DB by information provider registration information 517, and records the result in the decision distribution method log DB 551.

Subsequently, the distribution information extraction processing unit 542 extracts information to be distributed, based on the contents recorded in the master DB by information provider registration information 517, the decision distribution object contents DB 550, and the decision distribution method log DB 551 storing the distribution method determined by the distribution method decision processing unit 541, and then stores the extracted information in the distribution information DB by distribution method 553.

On the other hand, at this time, the object user extraction processing unit 543 extracts terminals 1 to which information is to be distributed, based on the contents recorded in the high-density distribution spot DB 536 which stores information about users (terminals 1) constituting a high-density distribution spot, and stores the result in the object user DB 552.

Then, the information distribution edition processing unit 544 associates the distribution information corresponding to the determined distribution method with terminals 1 to which the information is to be distributed, and then records the result in the distribution log DB 554. The information distribution execution processing unit 545 sends to each terminal 1 its corresponding distribution information via the user interface processing unit 501.

In this instance, if the information provider 7 has not registered distribution information beforehand (at enrollment), the ASP 5 requests the information provider 7 to provide distribution information including advice for determination of an effective distribution method and the information contents which are in agreement with the determined distribution method. That is, on the ASP 5, the notification information edition processing unit 546 edits and creates the contents to be notified to the information provider 7 based the information stored in the decision distribution method log DB 551, which stores the determined distribution method, and records the result in the notification log DB 555. The notification information execution processing unit 547 sends a notification that the distribution method has been determined to the corresponding information provider 7 via the information provider interface processing unit 511, thereby encouraging the information provider 7 to provide distribution information.

Here, in the above example, information distribution to users is performed based on the prediction result of the terminal distribution state obtained by the above-described “high-density distribution spot appearance state (movement displacement) evaluation function” which has already been described with reference to FIG. 10. In addition (or alternatively), the estimation result (the contents recorded in the approximation function DB 599) obtained by the approximation function estimating unit 594, which has already been described with reference to FIG. 11, can be used as the prediction result of the terminal distribution state, and it is of course possible to determine the distribution method, to extract distribution information, and to edit distribution information based on the above prediction result.

That is, when performing information distribution based on the prediction of the future terminal distribution state, the ASP 5 is capable of using monitoring results of the movement displacement of the terminal distribution state or using a history of the terminal distribution state in the past.

(B9) User Reaction Processing Function:

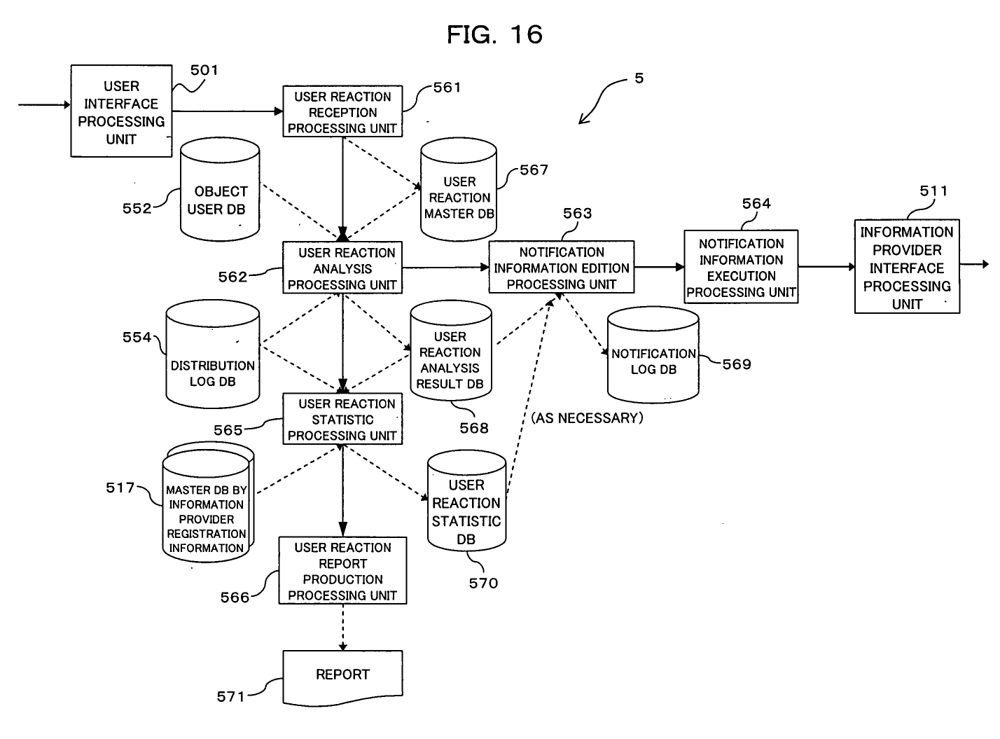

FIG. 16 is a functional block diagram showing a construction of an ASP 5 of the present embodiment with attention paid to a user reaction processing function of the ASP 5. As shown in FIG. 16, the present ASP 5 has the already-described user interface processing unit 501, information provider interface processing unit 511, master DB by information provider registration information 517, object user DB 552, and distribution log DB 554. In addition, as a “user reaction processing function”, the present ASP 5 includes: a user reaction reception processing unit 561; a user reaction analysis processing unit 562; a notification information edition processing unit 563; a notification information execution processing unit 564; a user reaction statistic processing unit 565; a user reaction report production processing unit 566; a user reaction master DB 567; a user reaction analysis result DB 568; a notification log DB 569; and user reaction statistic DB 570.

Here, when distribution information contains any arrangement for asking for responses (reactions) (for example, questionnaires, reservations, inquiries) from users of terminals 1, the “user reaction processing function” records responses from users and analyzes distribution effects immediately.

The user reaction reception processing unit 561 accepts reactions received from users of terminals 1 via the user interface processing unit 501, and the contents are recorded and stored in the user reaction master DB 567. The user reaction analysis processing unit 562 analyzes user responses (the time period from when information is distributed to user responses, and location information at that time) based on the contents recorded in the object user DB 552, which records the terminals 1 to which information is to be distributed, in the distribution log DB 554, which records distribution, and in the user reaction master DB 567, which records responses from the above users, and stores the results in the user reaction analysis result DB 568.

Further, in order to get a user response to the distributed information to the corresponding information provider 7, the notification information edition processing unit 563 edits a notification contents (messages) based on the contents recorded in the user reaction analysis result DB 568, and records and stores the edited contents in the notification log DB 569. The notification information execution processing unit 564 notifies the corresponding information provider 7 of the messages (response results of users) edited by the notification information edition processing unit 563 via the information provider interface processing unit 511.

The user reaction statistic processing unit 565 executes statistic processing on users' responses to distributed information, based on the contents recorded in the distribution log DB 554, which stores distribution information, and in the user reaction analysis result DB 568, which stores analysis results of users' responses, and in the master DB by information provider registration information 517, and records and stores the results in the user reaction statistic DB 570.

The user reaction report production processing unit 566 makes the statistics processing results obtained by the user reaction statistic processing unit 565 into a document, and creates a report 571.

With such a “user reaction processing function” incorporated, if the ASP 5 includes an arrangement for obtaining responses (reaction) from users of terminals 1, the ASP 5 is capable of recording responses from users and is also capable of providing the information provider 7, which is a supplier of the distribution information, with the user responses. In addition, the ASP 5 is also capable of immediately analyzing distribution effects brought about by the information distribution.

(B10) Information Provider Response Processing Function:

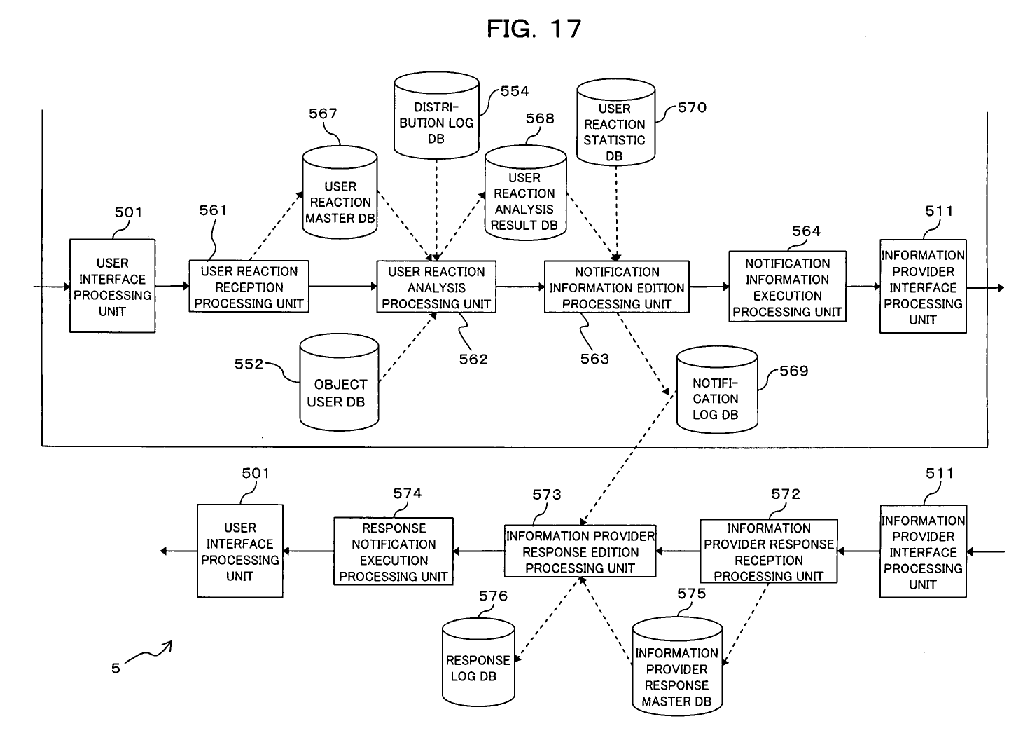

FIG. 17 is a functional block diagram showing a construction of the ASP 5 of the present embodiment with attention paid to an information provider response processing function of the ASP 5. As shown in FIG. 17, the present ASP 5 has not only the above-described “user reaction processing function”, which has already been described with reference to FIG. 16, but also an “information provider response processing function” which is realized by an information provider response reception processing unit 572, an information provider response edition processing unit 573, a response notification execution processing unit 574, an information provider response master DB 575, and a response log DB 576. In FIG. 16, like reference numbers and characters designate similar parts or elements which have already been described.

Here, the “information provider response processing function” is a function which makes it possible for the information provider 7 to respond to the response to the distributed information from users [for example, when a user responds to distribution information which asks for an advance order and makes an order, the information provider 7 responds to the above user by notifying the user of the confirmation of the order]. The “information provider response processing function” is a function as a user reaction processing means which analyzes the response to the distributed information from the terminal 1 of the service user and outputs the analysis result to an external apparatus.

The information provider response reception processing unit 572 accepts a response of the information provider 7 received via the information provider interface processing unit 511, and records and stores the contents in the information provider response master DB 575. The information provider response edition processing unit 573 edits and creates necessary messages to users, based on the contents recorded in the information provider response master DB 575, which stores responses from the information provider 7, and in the notification log DB 569 which notifies the information provider 7 of the reaction result from users. In addition, the notification information edition processing unit 573 also records and stores the fact of the response in the response log DB 576.

The response notification execution processing unit 574 sends the response (message) of the information provider 7 created by the above notification information edition processing unit 573 to the terminal 1 of the corresponding user via the user interface processing unit 501.

With the thus constructed “information provider response processing function”, the ASP 5 is capable of responding to the user reaction to distribute the information appropriately and precisely.

(B11) Distribution Information Request Processing Function:

FIG. 18 is a functional block diagram showing a construction of the ASP 5 of the present embodiment with attention paid to a distribution information request processing function of the ASP 5. As shown in FIG. 18, the present ASP 5 has the above-described distribution object contents DB 550 and notification log DB 569. In addition, as a “distribution information request processing function”, the present ASP 5 includes: a contents request edition processing unit 581; a contents request execution processing unit 582; a contents provider interface processing unit 583; a distribution contents reception processing unit 584; a distribution contents edition processing unit 585; a request contents log DB 586; and a distribution contents reception DB 587. In this instance, reference character 5A designates a contents provider, which includes a distribution contents master DB 50A storing distribution contents.

Here, the present “distribution information request processing function” is a function of notifying the contents provider 5A of distribution information which matches the distribution method determined as described above. Here, in this example, the contents provider 5A is different from the information provider 7. However, in cases where the above two are an identical corporation, essential functions and procedures are the same, and effects and advantages obtained from the “distribution information request processing function” are the same.

The above contents request edition processing unit 581 edits the contents which request the contents provider 5A to provide the distribution information which matches the determined distribution method based on the notification log DB 569 storing the contents notified to the information provider 7, and records and stores the edited contents in the request contents log DB 586. The contents request execution processing unit 582 sends to the corresponding contents provider 5A the request contents through the contents provider interface processing unit 583, which communicates information between the ASP 5 and the contents provider 5A.

The distribution contents reception processing unit 584 receives information from the contents provider 5A with respect to the above request via the contents provider interface processing unit 583, and records and stores the information in the distribution contents reception DB 587. The distribution contents edition processing unit 585 extracts and edits information to be actually distributed, based on the contents recorded in the distribution contents reception DB 587, which stores distribution information (contents) received from the contents provider 5A, and records and stores the results in the distribution object contents DB 556.

With the thus constructed “distribution information request processing function”, even if the information provider 7 has not received registration of distribution information beforehand, the ASP 5 is capable of requesting and obtaining the distribution information (contents) which matches the distribution method determined by the distribution method decision processing unit 541 (see FIG. 15) from the contents provider 5A. As a result, necessary and appropriate distribution information can be always assured and managed.

In summary, the ASP 5 has the following means on the assumption to realize the present information distribution service:

(a) a means having an interface for transceiving various information with the information provider 7, which means receives and records information about areas that is specified by the information provider 7 through the interface;

(b) a means having an interface for transceiving various information with terminals I carried by the service users, which means receives and records the location information of service users which is sent through the interface;

(c) a means for extracting and recording service users present in the area specified in (a);

(d) a means for dividing the area specified in (a) into unit blocks with an appropriate area and for recording the area specified (a) as a set of the unit blocks; and a means for identifying service users present in each unit block, and for calculating the distribution density by service users' property in each unit block and recording the calculation result;

(e) a means for treating more than one unit block as a single basic block, and for carrying out the distribution density calculation as in the case of (d) with respect to the basic block and for storing the result;

(f) a means for calculating information to be notified based on the contract with the information provider by means of various statistic processing, based on the distribution density of each property calculated in (d) or (e), and/or extracting the information based on any reference and recording the information;

(g) a means for notifying the information provider 7 of the information of (f);

(h) a means for receiving and recording the location of the information provider 7;

(i) a means for receiving information (information to be distributed) which should be distributed from the information provider 7;

(j) a means for receiving and recording the characteristics of service users, the area, the blocks which are objects to which a message from the information provider 7 is to be distributed;

(k) a means for extracting service users based on the various information stored based on the information of (j) and for sending the message received in (i) to the extracted service users;

[C] Description of Operation

Now, a description will be made of a main operation of the information distribution service provider system (ASP 5) of the present embodiment with the above-described construction.

With the above-described various functions, the ASP 5 is capable of distributing specified information to users 1 who have a characteristic specified as information distribution object and who are present in the area specified by the information provider 7 and the ASP administrator. If the area specified by the information provider 7 or the ASP administrator is close to the location of the information provider (for example, the area reachable on foot), the method by which distribution effect is evaluated to be high is selected, based on “the number of appearances of the high-density distribution spots at a certain time”, “a total number of appearances, the mean number of appearances, and the tendency of appearance, of the high-density distribution spots in a specified time period”, and “the tendency of change in the mean density and the tendency of change in the dispersion in the area during a specified period”. On the basis of the above method, it is possible to distribute specified information, and also the following service is also available.

That is, by using the above-mentioned “high-density distribution spot appearance state (movement displacement) evaluating function” (see FIG. 10) and the “information distribution function” (see FIG. 15), the ASP 5 evaluates the movement displacement from the tendency of appearance of the high-density distribution spots in the area in which distribution density calculation is to be performed with priority. As a result, it becomes possible (1) to provide concentrative information distribution service in the areas in which high-density distribution spots appear the next time, thereby providing information service with high cost performance to the information provider 7, and (2) to calculate the estimated distance to the information provider 7 and arrival time based on the movement displacement of the high-density distribution spots.

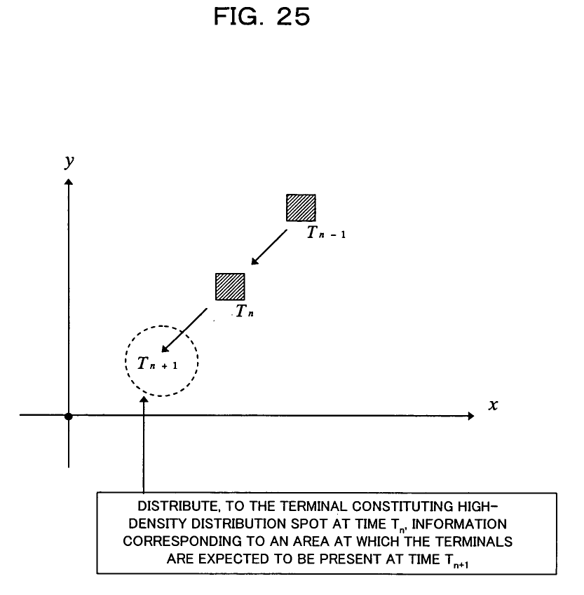

For example, on the basis of the time-series change in the high-density distribution spots, it becomes possible to perform information distribution concentrated in an area in which high-density distribution spots are expected to appear the next time. That is, when a set Sₙ of portable mobile information terminals Ms_{n,i} constituting the high-density distribution spot Pₙ at time Tₙ is given by the following formula (7):
Sₙ={MS_{n,i}}(i=1, . . . , k) (7)
if a rule that Pₙ moves to Pₙ₊₁ at time Tₙ₊₁ is observed, the set of terminals 1 constituting Pₙ₊₁ expressed by the following formula (8):
Sₙ₊₁={MS_{n+1,j}}(j=1, . . . 1) (8)
and Sₙ do not match completely, but from the definition of movement of the high-density distribution spots, it can be regarded that there are a lot of common elements. That is, when assuming that the elements of the set Sₙ₊₁ are almost the same as the elements of the set Sₙ, information distribution is performed to the terminal set Sₙ at time Tₙ₊₁, and high information distribution efficiency is expected (see FIG. 25).

In this manner, since the movement displacement of high-density distribution spot makes it possible to estimate the time and the distance required for the high-density distribution spot to reach the location of the information provider 7, it is possible for the information provider 7 to carry out marketing activity on the assumption of the time and the distance until the high-density distribution spot reaches the location of the information provider 7, and to carry out sales activity and information notification in conformity with the arrival time.

On the roads in rush or railways during rush hours in the area in which distribution density calculation is to be performed with priority, any characteristics such as movement displacement in the tendency of appearance of high-density distribution spots often cannot be discovered. In such a case, information is distributed to the whole of the distribution density calculation object areas.

Further, by means of making accurate the object area of the distribution density calculation or by means of data accumulation, it is possible to define the areas which are located at a specific distance from the information provider 7 or within a specific arrival time, or areas in which high-density distribution spots appear at high probability.

(C1) Business Application 1:

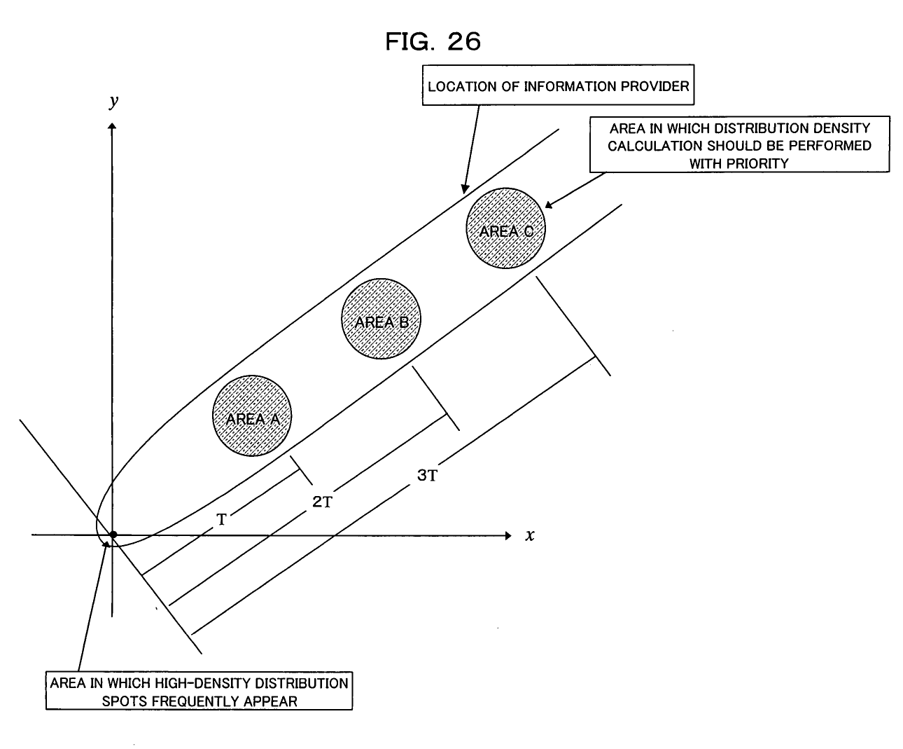

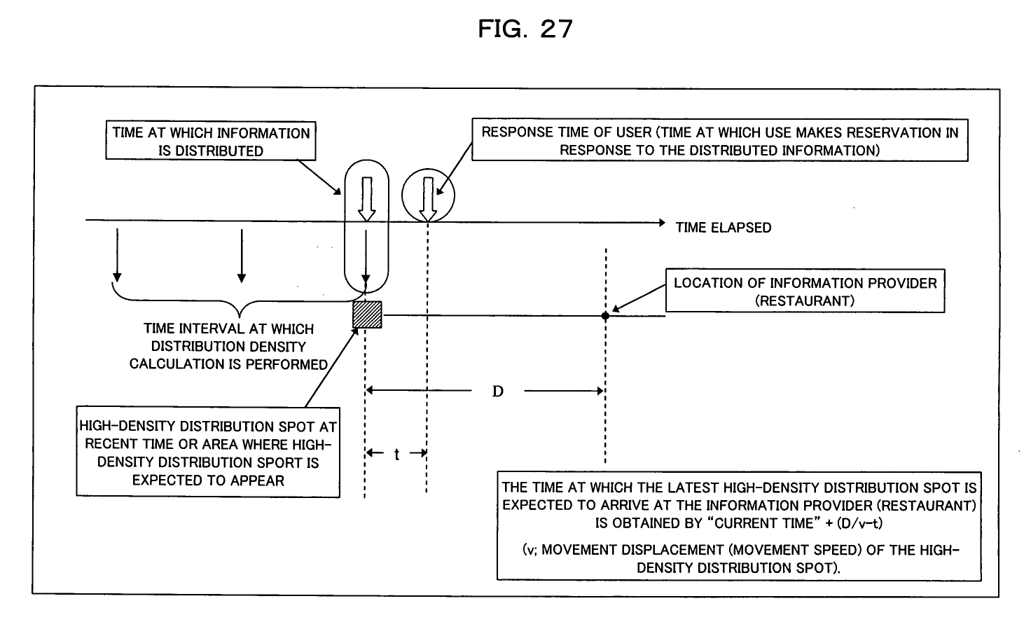

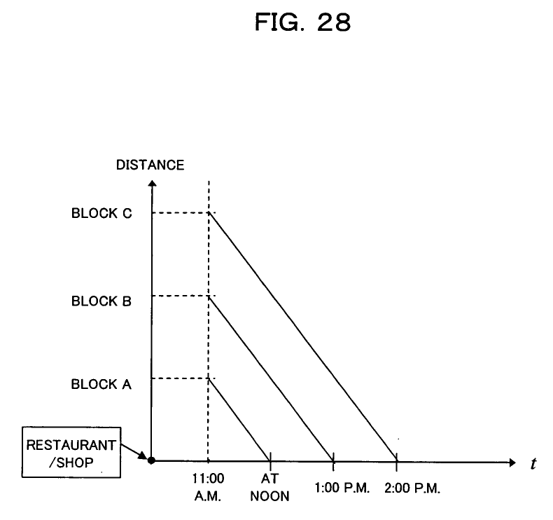

As shown in FIG. 26, FIG. 27, and FIG. 28, for example, it is assumed that the ASP 5 [“high-density distribution spot appearance state (movement displacement) evaluating function] observes areas (area A, area B, and area C) in which high-density distribution spots frequently appear in areas which are located at places which are away from the location of the information provider 7 (for example, a restaurant, etc.) specific distances. More specifically, the area A is located at T hour's automobile ride from the location of the information provider 7; the area B is located at 2 T hour's automobile ride from the location of the information provider 7; the area C is located at 3 T hour's automobile ride from the location of the information provider 7.

In such a case, it is possible for the information provider 7 to distribute different information contents to the areas A, B, and C at different distribution frequencies, thereby realizing information distribution with high cost performance. That is, as shown in FIG. 27, the time when the latest high-density distribution spot is estimated to arrive at the location of the information provider 7 can be obtained by “the current time”+(D/v−t) [where D is the distance from the location of the information provider 7 to the high-density distribution spot; v is the movement displacement (movement velocity) of the high-density distribution spot; t is a reaction time (the time when the user makes a reservation in response to the distribution information)]. Thus, the information provider 7 is capable of changing the information contents to be distributed or the information distribution frequency in accordance with the estimated time.

More specifically, assuming that the information provider 7 is a restaurant located along a road, and that the current time is 11:00 a.m., and the lunch time service is provided from noon to 1:00 p.m. The information distribution for encouraging customers to come to the restaurant during the lunch-time service hour is sent to users with user property which requests such kind of information. In addition, the high-density distribution spots with such property are located at area A, area B, and area C shown in FIG. 28, and it takes 1 hour, 2 hours, and 3 hours, respectively, for users to come from the above spots to the restaurant.

Here, the users' demand and interest in the information distributed by the restaurant depends on the users' current situation. Thus, the information contents distributed at the current time (11:00 a.m.) should be different, depending upon the location of the users.

More specifically, the probability that users who are located in area A which is a one-hour ride from the restaurant come to the restaurant during the lunchtime service hour is considerably high. Since the users are thus recognized as a user group which is highly expected to come to the restaurant at lunchtime. Hence, the information distributed to this user group should contain the information about the lunchtime service and merits of reservation, and the information distribution should be carried out at high frequency.

In contrast, the probability that the user group located in area B, which is a 2-hour ride from the restaurant, come to the restaurant during the lunchtime service hour is low. Thus, even if the information about the lunchtime service is contained in the distribution information to this user group, the request level and the distribution frequency should be low.

Distributing the lunchtime service information to users who are located in area C, which is a 3-hour ride from the restaurant, is meaningless. Thus, the lunchtime service information sent to the users in area C is “spam”, and it affects the evaluation of the restaurant. Hence, to the users located in area C, information encouraging the user to take a rest at the restaurant with a nice view or information about tea-time service should be sent.

In this manner, in the ASP 5, since the distribution method decision processing unit 541 (see FIG. 15), which functions as “distribution information function”, determines information to be distributed to each high-density distribution spot, the information provider 7 (in this example, a restaurant) is capable of distributing information which is suitable for the location of the high-density distribution spot, whereby high distribution efficiency and improvement in profit can be expected.

(C2) Business Application 2:

Further, the ASP 5 can utilize users' reactions to the information distributed by the information provider 7. This makes it possible to improve the profit of the information provider 7. More specifically, when users respond (make reservations) to the distribution information provided by the information provider 7 (restaurant), the ASP 5 [“user reaction processing function” (see FIG. 16)] notifies the restaurant of “name”, “the number of customers”, “orders”, and “estimated arrival time” of users who respond (makes reservations) to the distributed information. This improves efficiency of the operation of the restaurant.

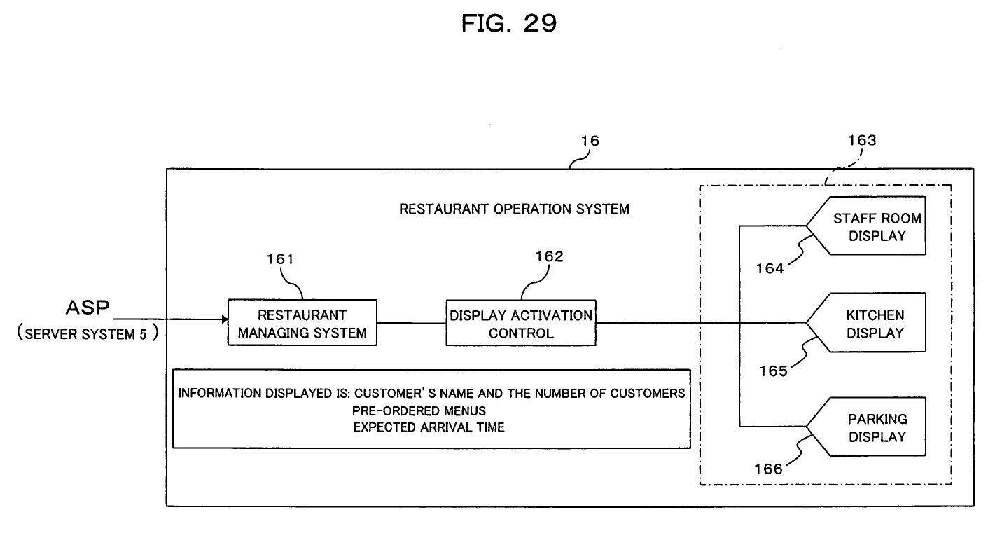

For example, as shown in FIG. 29, the restaurant operation system of the restaurant, which is the information provider 7, includes an interface function (restaurant managing system) 161 and a function (display activation control unit) 162 of activating and controlling equipment 163, which displays responses (reservation) of users to whom information is distributed from the ASP 5 (the notification information execution processing unit 564 of FIG. 16). With such functions, reservation contents are displayed in a staff room or a kitchen (see reference characters 164 and 165), and a reservation is displayed (see reference character 166) for reserving a parking place and seats in the restaurant. As a result, the restaurant can be well prepared to welcome the customers (who made a reservation). In addition, the users (who made a reservation) do not need to search for a parking place or wait for seats. Thus, it is possible for the customers to receive service as quickly as possible at the moment of their arrival at the restaurant.

(C3) Business Application 3:

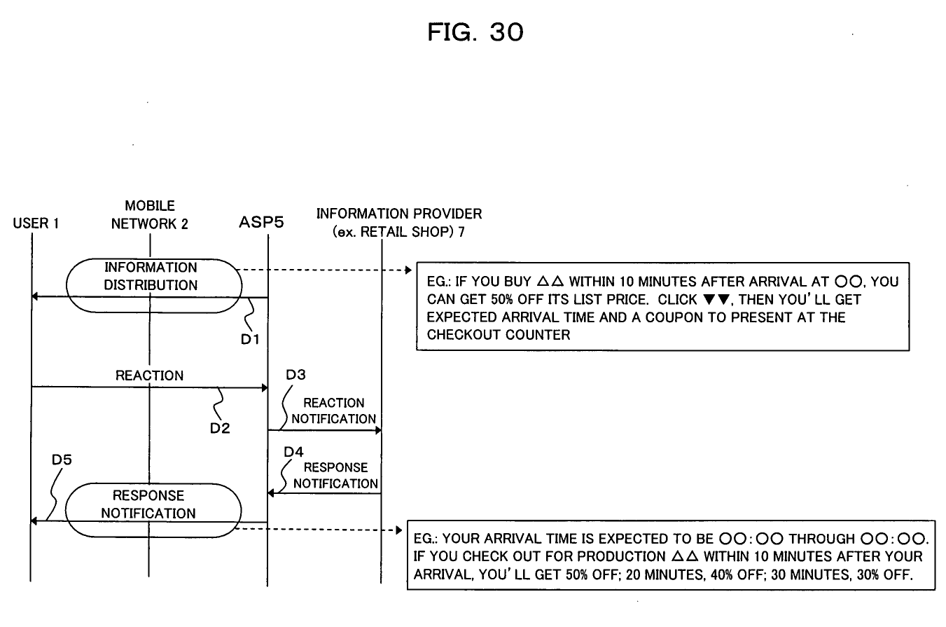

Further, if the information provider 7 is a retail store, it is possible to add “electronic discount coupons”, which encourage customers to come to the store, to the distribution information. This makes it possible to develop a new sales method corresponding to the customers' estimated arrival time. For example, as shown in FIG. 30, the ASP 5 distributes information, “if you buy Product ΔΔ within 10 minutes after your arrival at our store XX, you can get 50% OFF. Click ▾▾, and then you can get a display of your estimated arrival time and a coupon to be presented at a checkout.” (step D1). If a user reacts to this information, the ASP 5 [“user reaction processing function” (see FIG. 16)] notifies the information provider 7 (retail store) of the reaction (steps D2 and D3).

Then, as a response notification to the customer's response notification, the information provider 7 sends a message, “You will arrive at our store XX from 12:15 to 12:20. If your check out time for Product ΔΔ is within 10 minutes of your arrival at our store, you can get 50% OFF; if your check out time for Product ΔΔ is within 20 minutes after arrival at our store, you can get 40% OFF; if your check out time for Product ΔΔ is within 30 minutes after arrival at our store, you can get 30% OFF.” to the ASP 5 (step D4). Upon receipt of this response notification, the ASP 5 sends the response notification to the user by means of the “information provider response processing function”, which has already been described with reference to FIG. 17 (step D5).

In this manner, according to the ASP 5, the application of different discount rates depending upon the time period-from the customer's arrival time at a store to the check out time becomes available.

[D] Payment Method

Now, a description will be made of the payment procedures for services, necessary among users of the above information distribution service, the information provider 7, and the mobile communication carrier (mobile carrier) which operates and manages the mobile network 2.

Generally speaking, a mobile communication carrier charges a subscriber for a communication fee, which includes a service charge for monthly use and a network usage fee. The communication fee is charged directly to the subscriber's bank account, thereby payment for the communication fee is completed. Of the communication fee, a few percent of the service charge is taken by the mobile communication carrier, and the remainder is paid to the service provider (ASP) by payment between the banks.

Hence, in the present embodiment, the above fee collection deputizing operation, which is performed by mobile communication carriers, is utilized as it is. In addition, the ASP 5 simplifies the payment process among users, the information provider 7, and the mobile communication carrier, by brokering the payment process relating to the present information distribution service.

(D1) In Cases Where Location of the Information Provider 7 is Fixed:

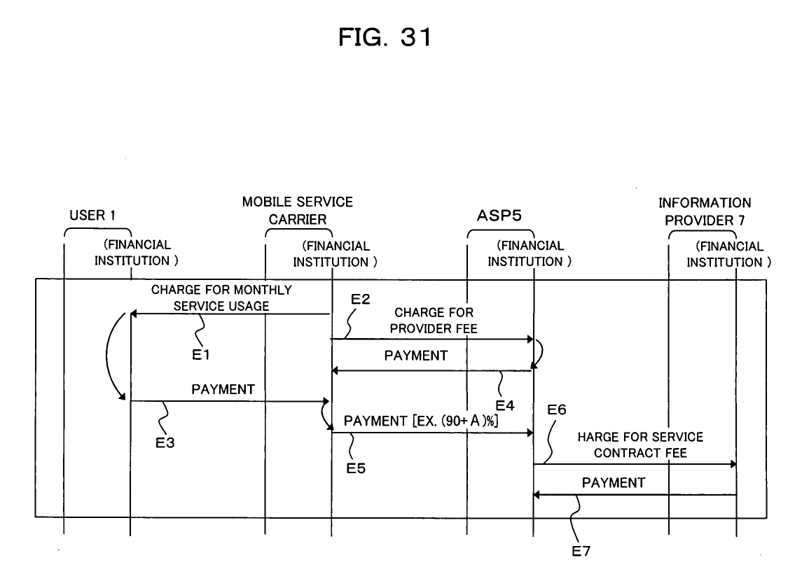

When the location of the information provider 7 is fixed (when the company's bank of the information provider 7 is registered at enrolment), as shown in FIG. 31, the mobile communication carrier charges users (subscribers) 1 of the present information service for a monthly communication fee. The mobile communication carrier also charges the ASP 5, which is a provider of the present information distribution service, for a connection contract fee (step E1 and step E2).

The user 1 and the ASP 5 pay the charged fees to the mobile carrier through settlement between their contracted financial institutions (banks) and the contracted financial institution (bank) of the mobile carrier (step E3 and step E4). The ASP 5 receives the payment (for example, 90% of the communication fee) of the present information distribution service users after subtracting the commission fee of the mobile communication carrier by means of inter-bank payment (step E5).

In addition, the ASP 5 charges the information provider 7, which is also a user of the present information distribution service, for a contraction fee determined by the information distribution condition (step E6), and receives the contraction fee from the information provider 7's bank by means of inter-bank payment (step E7).

(D2) In Cases Where Location of the Information Provider 7 is not Fixed:

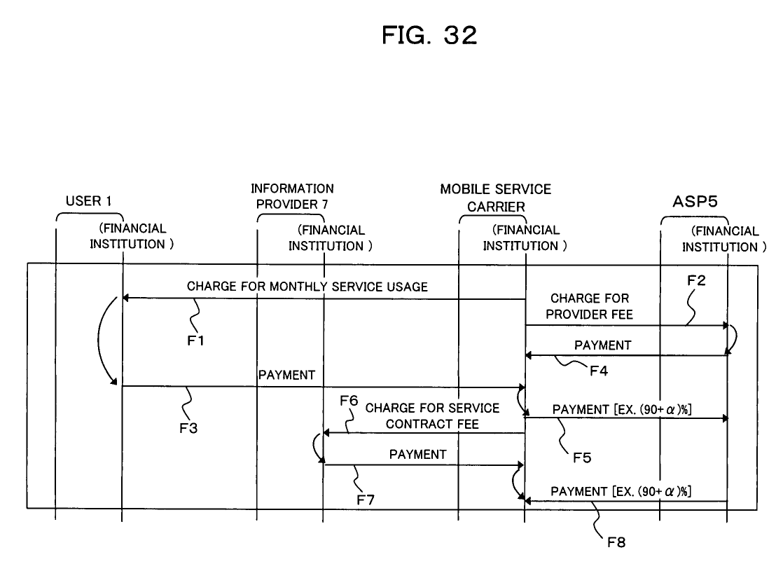

In contrast, a description will be made hereinbelow of a case where the location of the information provider 7 is not fixed (when the information provider distributes information from a portable mobile information terminal 7). For example, when the information provider 7 is a mobile retailer such as a promoter of open-air events such as street performance or a mobile lunchbox shop, the mobile communication provider, as shown in FIG. 32, charges users (subscribers) 1 of the service of the present embodiment for a monthly charge for a communication fee (step F1). In addition, the mobile communication provider charges the ASP 5, which is a provider of the present information distribution service, for a connection contract fee (step F2).

In contrast, users 1 and the ASP 5 pay the charged fees to the mobile communication carrier by inter-bank payment between their contracted financial institution (bank) and the contracted financial institution (bank) of the mobile carrier (step F3 and step F4). The ASP 5 receives the payment (for example, 90% of the communication fee) which is obtained by subtracting the commission fee of the mobile communication carrier from the communication fee paid by the users of the present information distribution service, by inter-bank payment (step F5).

Further, the mobile communication carrier charges the information provider 7, which is a subscriber of the present information distribution service, for a contract fee (step F6). The information provider 7 pays the charged fee to the mobile communication carrier by inter-bank payment (step F7). The ASP 5 receives the amount (for example, 90%) which is obtained by subtracting the commission fee of the mobile communication provider from the payment of the information provider 7 by inter-bank payment (step F8).

(D3) In Cases Where the ASP 5 also Runs a Net-bank or the ASP 5 is Involved in the Business Cooperation with a Net-bank, and When the Service User Has an Account in the Net-bank:

When the ASP 5 runs a net-bank, or when the ASP 5 is involved in the business cooperation with a net-bank, and when users 1 of the present information distribution service have accounts in the net-bank, the commission fee for the inter-bank payment can be reduced. Thus, it is possible for the ASP 5 to pass the savings on to their customers in the form of discount of the service fee and so on.

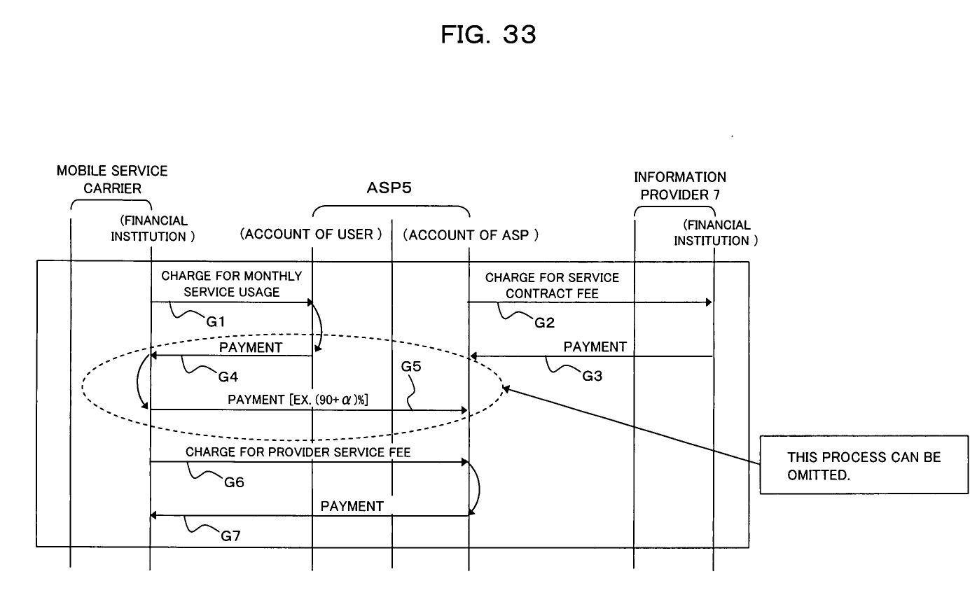

That is, as shown in FIG. 33, the mobile communication carrier charges users 1 of the present information distribution service for a monthly communication fee (step G1), and also, the mobile communication carrier charges the ASP 5, which is a provider of the preset information service, for a connection contract fee (step G6). At this time, the mobile communication provider charges the fee of the mobile terminal 1 to a net-bank which is run by the ASP 5.

The ASP 5 charges the information provider 7, which is also a user of the present information distribution service, for the payment of contracted amount determined based on information distribution condition (step G2), and receives the charged contract amount from the financial institution with which the information provider 7 is contracted by means of inter-bank payment (step G3).

Here, if the ASP 5 runs a net-bank or is involved in business cooperation with a net-bank, and if the service users 1 have bank accounts in the net-bank, the process (step G4 and G5) of payment of the communication fee of the users 1 between the net-bank run by the ASP 5 or the bank which is involved in business cooperation with the ASP 5 and the mobile communication carrier's bank can be omitted, and the amount of fee is returned to the users 1 by means of cutting of the service fee.

In this instance, the ASP 5 pays the connection contraction fee charged from the communication carrier to the communication carrier's financial institution from the account of the ASP 5 of the net-bank (step G7).

(D4) In Cases Where the ASP 5 Runs a Net-bank, or the ASP 5 is Involved in Business Cooperation with a Net-bank, and both of the Service Users 1 and the Information Provider 7 Have Accounts in the Net-bank:

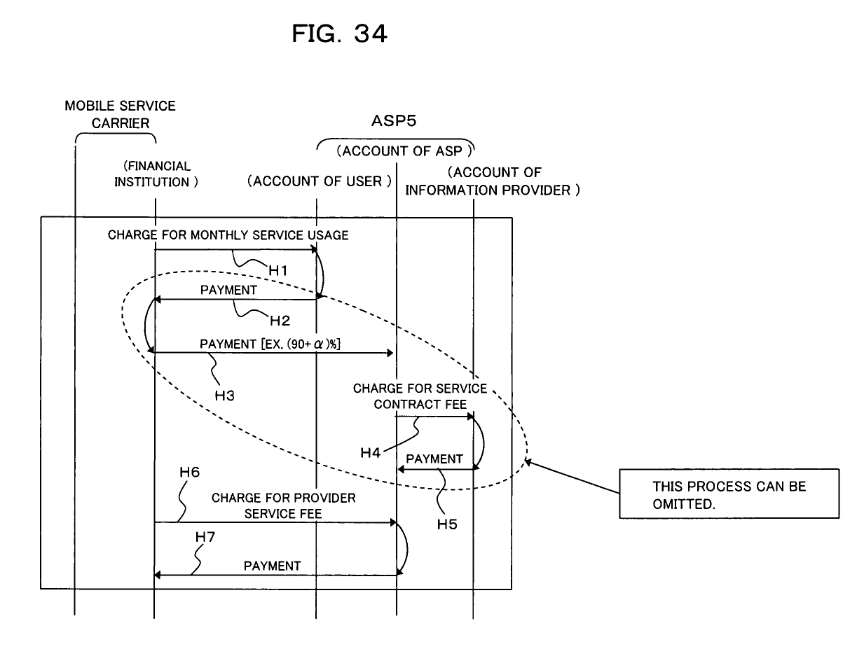

In this case, as shown in FIG. 34, the mobile communication carrier charges users 1 of the present information distribution service, who are subscribers, for a monthly communication fee, and also charges the ASP 5, which is a service provider of the present information distribution service, for a connection contract fee. At this time, the accounts to which the charges are performed are the accounts of a net-bank run by the ASP 5 or a net-bank which is involved in business cooperation with the ASP 5 (steps H1 and H6).

In this case, the service users land the information provider 7 have their accounts in the net-bank. Thus, since almost all the payment transaction is performed between the accounts of the net-bank (the procedures designated by step H2 through H5 in FIG. 34 can be omitted), its commission fee can be returned to the service users 1 and the information provider 7 by reduction of the fee for the service (step H7).

As described so far, the present invention monitors time-series change in terminal distribution density of service users with a specified user property in information distribution object areas. On the basis of the monitoring result, the future terminal distribution density is predicted, and information distribution is performed. Thus, the information provider is capable of providing information distribution service such as advertisement information in which financial rationality and cost performance is improved. In contrast, the users of the service can receive an information distribution service which is high in validity and suitability. Therefore, the present invention is significantly useful in the present service field.

What is claimed is:

1. An information distribution service providing system, comprising:
a server system which provides a plurality of mobile information terminals, carried by a plurality of users who have been registered as users of information distribution service, with the information distribution service via a communication network; and
a terminal of an information distribution requester, which terminal communicates with the server system and specifies a user characteristic and information distribution object areas for the users to whom information is to be distributed by the information distribution service,
said server system including:
distribution state change monitoring means which monitors change over time in distribution of the mobile information terminals of the users with the user characteristic in the information distribution object area, based on location information of the mobile information terminal;
distribution state predicting means which predicts a distribution state of the mobile information terminals in the future based on the monitoring result obtained by said distribution state change monitoring means; and
information distributing means which distributes information to the mobile information terminals of the users based on the prediction result obtained by the distribution state predicting means.

2. An information distribution service providing system as set forth in claim 1,
wherein said distribution state change monitoring means includes:
a distribution density calculating unit which calculates distribution density of mobile information terminals of the service users with the user characteristic, in a specified block included in the information distribution object area, based on location information of the mobile information terminal; and
a high density distribution area detecting unit which detects a high density distribution area, in which the distribution density is higher than a predetermined density, based on the calculation result obtained by said distribution density calculating unit,
wherein said distribution state predicting means includes:
a high density distribution area movement displacement calculating unit which calculates movement displacement of the high density distribution area detected by said high density distribution area detecting unit; and
a high density distribution area movement predicting unit which predicts a destination to which the high density distribution area moves, based on the movement displacement obtained by said high density distribution area movement displacement calculating unit, and
wherein said information distribution means includes an information distributing unit of a high density distribution area prediction type, which information distributing unit selects information corresponding to the destination of movement, predicted by said high density distribution block movement predicting unit, and distributes the selected information.

3. An information distribution service providing system as set forth in claim 1, wherein said information distribution means includes:
a distance/arrival time estimating unit which estimates the distance and/or the time required to move from the high density distribution block to a place where the information distribution requester is located or a place specified by the information distribution requester, based on the calculation result obtained by said high density distribution area movement displacement calculating unit; and
an information distributing unit of a distance/arrival time estimation type, which information distributing unit distributes information corresponding to the distance and/or the arrival time estimated by said distance/arrival time estimating unit to the mobile information terminals within the high density distribution area.

4. An information distribution service providing system as set forth in claim 3, wherein said information distributing means includes a distribution information recommending unit which makes recommendations with respect to to-be-distributed information corresponding to the distance/arrival time estimated by said distance/arrival time estimating unit.

5. An information distribution service providing system as set forth in claim 2, wherein said information distributing means includes a high-density distribution area movement prediction result notifying unit which notifies the information distribution requester's terminal of the prediction result,obtained by said high density distribution block movement predicting unit.

6. An information distribution service providing system as set forth in claim 1, wherein said server system includes user reaction processing means which analyzes reaction of the service users' mobile terminals to information distributed from said information distributing means, and then outputs the analysis result to an external apparatus.

7. An information distribution service providing system as set forth in claim 1, wherein said distribution state predicting means includes an approximation function estimating unit which predicts the distribution state by estimating an approximation function with respect to change over time in the future distribution state based on a history of monitoring result in the past obtained by said distribution state change monitoring means.

8. An information distribution method for an information distribution service providing system which includes: a server system which provides a plurality of mobile information terminals, carried by a plurality of users who have been registered as users of information distribution service, with the information distribution service via a communication network; and a terminal of an information distribution requester, which terminal communicates with the server system and specifies a user characteristic and information distribution object areas for the users to whom information is to be distributed by the information distribution service, said method comprising:
on the server system,
monitoring change over time in distribution of the mobile information terminals of the users with the user characteristic in the information distribution object area, based on location information of the mobile information terminals;
predicting a distribution state of the mobile information terminals in the future based on the monitoring result; and
distributing information to the mobile information terminals of the service users based on the prediction result.

9. An information distribution method as set forth in claim 8, wherein the server system performs the following:
calculating distribution density of mobile information terminals of the service users with the user characteristic in a specified block included in the information distribution object area, based on location information of the mobile information terminal;
detecting a high density distribution area, in which the distribution density is higher than a predetermined density, based on the calculation result;
calculating movement displacement of the high density distribution area;
predicting a destination to which the high density distribution area moves, based on the thus-obtained movement displacement; and
selecting information corresponding to the destination of movement predicted, and distributing the corresponding information.

10. An information distribution method as set forth in claim 8, wherein the server system performs the following:
estimating the distance and/or the time required to move from the high density distribution block to a place where the information distribution requester is located or a place specified by the information distribution requester, based on the movement displacement obtained by the above-mentioned calculation; and
distributing information corresponding to the distance and/or the arrival time estimated to the mobile information terminals within the high density distribution area.

11. An information distribution method as set forth in claim 10, wherein said server system makes recommendations with respect to to-be-distributed information in accordance with the thus estimated distance/arrival time to the terminal of the information distribution requester.

12. An information distribution method as set forth in claim 9, wherein said server system notifies the information distribution requester's terminal of the result of prediction about a destination of the high density distribution area.

13. An information distribution method as set forth in claim 8, wherein said server system analyzes reaction of the service users' mobile terminals to information distributed to the service users' mobile terminals based on the distribution state prediction result, and then outputs the analysis result to an external apparatus.

14. An information distribution method as set forth in claim 8, wherein said server system predicts the distribution state by estimating an approximation function with respect to change over time in the future distribution state based on a history of monitoring result in the past distribution state.

15. A server system for use in an information distribution service providing system which includes: a server system which provides a plurality of mobile information terminals, carried by a plurality of users who have been registered as users of information distribution service, with the information distribution service via a communication network; and a terminal of an information distribution requester, which terminal communicates with the server system and specifies a user characteristic and information distribution object areas for the users to whom information is to be distributed by the information distribution service, said server system comprising:
distribution state change monitoring means which monitors change over time in distribution of the mobile information terminals of the users with the user characteristic in the information distribution object area, based on location information of the mobile information terminal;
distribution state predicting means which predicts distribution state of the mobile information terminals in the future based on the monitoring result obtained by said distribution state change monitoring means; and
information distributing means which distributes information to the mobile information terminals of the users based on the prediction result obtained by the distribution state predicting means.

16. A server system for use in the information distribution providing system as set forth in claim 15,
wherein said distribution state change monitoring means includes:
a distribution density calculating unit which calculates distribution density of mobile information terminals of the service users with the user characteristic in a specified block included in the information distribution object area, based on location information of the mobile information terminals;
a high density distribution area detecting unit which detects a high density distribution area, in which the distribution density is high, based on the calculation result obtained by said distribution density calculating unit; and
a high density distribution area movement displacement calculating unit which calculates movement displacement of the high density distribution area detected by said high density distribution area detecting unit,
wherein said distribution state predicting means includes a high density distribution area movement predicting unit which predicts a destination to which the high density distribution area moves, based on the movement displacement obtained by said high density distribution block movement displacement calculating unit, and
wherein said information distribution means includes an information distributing unit of a high density distribution area prediction type, which information distributing unit selects information corresponding to the destination of movement, predicted by said high density distribution area movement predicting unit, and distribute the information.

17. A server system for use in the information distribution providing system as set forth in claim 15, wherein said information distribution means include:
a distance/arrival time estimating unit which estimates the distance and/or arrival time from the high density distribution area to a place where the information distribution requester is located or a place specified by the information distribution requester, based on the calculation result obtained by said high density distribution area movement displacement calculating unit; and
an information distributing unit of a distance/arrival time estimation type, which information distributing unit distributes information corresponding to the distance and/or the arrival time estimated by said distance/arrival time estimating unit to the mobile information terminals within the high density distribution block.

18. A server system for use in the information distribution providing system as set forth in claim 16, wherein said information distributing means includes a high-density distribution area movement prediction result notifying unit which notifies the information distribution requester's terminal of the prediction result obtained by said high density distribution area movement predicting unit.

19. A server system for use in the information distribution providing system as set forth in claim 15, said server system further comprising user reaction processing means which analyzes reaction of the service users' mobile terminals to information distributed from said information distributing means, and then outputs the analysis result to an external apparatus.

20. A server system for use in the information distribution providing system as set forth in claim 15, wherein said distribution state predicting means includes an approximation function estimating unit which predicts the distribution state by estimating an approximation function with respect to change over time in the future distribution state based on a history of monitoring result in the past obtained by said distribution state change monitoring means.
